(19) United States
(12) Patent Application Publication
(10) Pub. No.: US 2020/0299581 A1
(43) Pub. Date: Sep. 24, 2020

(54) OPTICALLY ISOTROPIC LIQUID CRYSTAL COMPOSITION AND OPTICAL SWITCHING DEVICE USING SAME

(71) Applicants: JNC CORPORATION, Tokyo (JP); JNC PETROCHEMICAL CORPORATION, Tokyo (JP)

(72) Inventors: Eiji OKABE, CHIBA (JP); HITOSHI TOBATA, CHIBA (JP)

(73) Assignees: JNC CORPORATION, Tokyo (JP); JNC PETROCHEMICAL CORPORATION, Tokyo (JP)

(21) Appl. No.: 16/823,350

(22) Filed: Mar. 19, 2020

(30) Foreign Application Priority Data
Mar. 20, 2019 (JP) 2019-053130
Jan. 7, 2020 (JP) 2020-000674

(51) Int. Cl. C09K 19/34; C09K 19/58; C09K 19/56; C09K 19/02; G02F 1/1334

(52) U.S. Cl. CPC C09K 19/3402; C09K 19/586; C09K 19/56; G02F 2203/13; G02F 1/1334; C09K 2019/3422; G02F 2203/11; C09K 19/0216

(57) ABSTRACT

A device using a liquid crystal medium exhibiting an optically isotropic liquid crystal phase, particularly, a blue phase liquid crystal medium for polarized light control application, in which reduction of an effective dielectric constant in a high frequency region is suppressed. A liquid crystal composition contains achiral component T, and has a liquid crystal phase optically exhibiting isotropy, in which achiral component T contains at least one compound selected from the group of compounds represented by formula (1) as a first component, at least one compound selected from the group of compounds represented by formula (2) and formula (3) as a second component, and is used for optical switching for controlling retardation by electric field-induced birefringence.

### CROSS-REFERENCE TO RELATED APPLICATION

This application claims the priority benefit of Japan application no. 2019-053130, filed on Mar. 20, 2019 and Japan application no. 2020-000674, filed on Jan. 7, 2020. The entirety of each of the above-mentioned patent applications is hereby incorporated by reference herein and made a part of this specification.

### BACKGROUND

### Technical Field

The disclosure relates to a liquid crystal medium (a liquid crystal composition, a polymer/liquid crystal composite material and so forth) exhibiting an optically isotropic liquid crystal phase to be used in an optical switching device, for example, a laser imaging detection and ranging (LIDAR), a mixture of a polymerizable monomer or the like and the liquid crystal composition, and a device using the same.

### Background Art

An optical switching device is a device that switches or turns on/off an optical path, and a system thereof includes a mechanical system, an electronic system, an all-optical system and so forth. The mechanical system is a system of mechanically moving a prism, a mirror or an optical fiber, and examples of the electronic system include a system using an electro-optical effect, a magneto-optical effect, a thermo-optic effect or a semiconductor gate. The all-optical system is a system using a nonlinear refractive index change, and a system using a liquid crystal medium exhibiting an isotropic liquid crystal phase falls under the all-optical system. The optical switching device can preferably control light having a wide range of wavelength, and can further preferably control light of visible light (wavelength: 0.38 to 0.78 μm), near-infrared rays (wavelength: 0.72 to 2.5 μm) or millimeter waves (wavelength; 1 to 10 mm).

A LIDAR is one of remote sensing technologies for measuring a distance, a direction or the like of an object from reflected light, in which a laser beam having a short wavelength in a near-infrared range (wavelength: 0.72 to 2.5 μm) is used. A mechanical device such as micro electro mechanical systems (MEMS) is studied for polarized light control, but has many issues such as difficulty in controlling a steering angle and poor durability because a movable part is of the mechanical system.

The polarized light control by the device using the liquid crystal medium is performed by an electro-optical response of the liquid crystal medium. Incident light is converted into elliptically polarized light, linearly polarized light, circularly polarized light or the like. The device using the liquid crystal medium is used, whereby the device can be used as an optical switching device by only an electric operation with getting rid of mechanical driving. Moreover, in order to switch an optical path with a high speed in the device using the liquid crystal medium, a device in which an effective dielectric constant in a high frequency region is not reduced is preferably used.

In the device using the liquid crystal medium for polarized light control application, a nematic liquid crystal medium is used, but a response time is long, and therefore the device has an issue of the limited number of times of control per fixed time. As the liquid crystal medium capable of the polarized light control by the electro-optical response in a manner similar to the nematic liquid crystal medium, a blue phase liquid crystal medium, which is one of optically isotropic liquid crystal phases, is known (Patent literature No. 1: WO 2018/003658 A). Above all, the blue phase liquid crystal medium that can be preferably used in a device suppressing reduction of the effective dielectric constant in the high frequency region is reported (Patent literature No. 2: JP 2018-070675 A). A wavelength variable filter, a wavefront control device, a liquid crystal lens, an aberration correction device, an aperture control device, an optical head device and so forth, using electric field-induced birefringence, have been proposed so far (Patent literature No. 3: JP 2005-157109 A; Patent literature No. 4: WO 2005/80529 A; and Patent literature No. 5: JP 2006-127707 A).

As described above, in a mechanical device studied for polarized light control application, issues of difficulty in controlling a steering angle and poor durability and so forth have remained. Moreover, in a device using a nematic liquid crystal medium, a response time is long, whereby the number of controls per fixed time has been limited. Further, in order to switch an optical path at a high speed, a device in which reduction of an effective dielectric constant in a high frequency region is suppressed has been required.

The present inventors have diligently studied, and as a result, have found that a device using a liquid crystal medium exhibiting an optically isotropic liquid crystal phase, particularly, a blue phase liquid crystal medium, in which reduction of an effective dielectric constant in a high frequency region is suppressed, can be preferably used for polarized light control application, and have completed the disclosure.

The disclosure provides, for example, a liquid crystal medium (such as a liquid crystal composition and a polymer/liquid crystal composite material), a mixture of a polymerizable monomer or the like and the liquid crystal composition, and an optical switching device including the liquid crystal medium or the like, as described below.

### SUMMARY

A liquid crystal composition having a liquid crystal phase optically exhibiting isotropy to be used for optical switching for controlling retardation by electric field-induced birefringence, wherein a peak top of a dielectric dissipation factor is located at a frequency higher than 10 kHz.

### BRIEF DESCRIPTION OF DRAWINGS

FIG. 1 shows an optical system used in Examples.

### DESCRIPTION OF EMBODIMENTS

A term “liquid crystal compound” herein represents a compound having a mesogen, and is not limited to a compound having a liquid crystal phase. Specifically, the liquid crystal compound is a generic term of a compound having the liquid crystal phase such as a nematic phase and a smectic phase and a compound having no liquid crystal phase but being useful as a component of a liquid crystal composition.

A term “liquid crystal composition” means a mixture prepared by mixing a plurality of liquid crystal compounds, and an additive such as an optically active compound, an antioxidant, an ultraviolet light absorber, a dye, an antifoaming agent, a polymerizable compound, a polymerization initiator and a polymerization inhibitor is added thereto, when necessary.

A term “liquid crystal medium” is a generic term for the liquid crystal composition and a polymer/liquid crystal composite material.

A term “achiral component” means an achiral mesogen compound, which is a component containing neither the optically active compound nor a compound having a polymerizable functional group. Accordingly, the “achiral component” includes no chiral agent, no polymerizable monomer or the like, no polymerization initiator, no curing agent and no stabilizer.

A “chiral agent” is the optically active compound, and is a component used for providing the liquid crystal composition with a desired twisted molecular arrangement.

A term “device” abstractly represents an object exhibiting a required function, and the device relating to optical properties is referred to as an optical device or an optical element. Moreover, the device using the liquid crystal medium may be occasionally referred to as a liquid crystal device based on a used material.

A term “optical device” refers to various devices using an electro-optical effect to produce a function such as optical modulation and an optical switch, and specific examples thereof include an optical modulation device and an optical switching device used in a display device (liquid crystal display device), an optical communication system, optical information processing or various sensor systems.

Moreover, the term “optical switching device” means a device that turns on/off or partitions an optical signal to switch a route with keeping light without converting the optical signal into an electric signal.

A change in a refractive index by voltage application to an isotropic optically liquid crystal medium is known as a Kerr effect. The term “Kerr effect” means a phenomenon in which an electric birefringence value Δn(E) is proportional to a square of an electric field E, and an equation: Δn(E)=KλE² holds in a material exhibiting the Kerr effect (K: Kerr coefficient (Kerr constant), λ: wavelength). Here, the term “electric birefringence value” means a refractive index anisotropy value induced when the electric field is applied to an isotropic medium.

A term “selective reflection” means that one of right-handed and left-handed circularly polarized light components of light that enters in parallel to a helical axis of chiral nematic liquid crystal or cholesteric liquid crystal is specifically reflected.

The terms “liquid crystal compound” and “liquid crystal composition” may be occasionally abbreviated as “compound” and “composition,” respectively.

Moreover, for example, a maximum temperature of the liquid crystal phase is a phase transition temperature between the liquid crystal phase and an isotropic phase, and may be occasionally abbreviated simply as a clearing point or a maximum temperature. A minimum temperature of the liquid crystal phase may be occasionally abbreviated simply as a minimum temperature. Moreover, a maximum temperature of an optically isotropic liquid crystal phase, for example, a blue phase is a phase transition temperature between the blue phase and the isotropic phase, and a minimum temperature of the blue phase is a phase transition temperature between the blue phase and a crystal.

A compound represented by formula (1) may be occasionally abbreviated as compound 1. The abbreviation may occasionally apply to a compound represented by formula (2) and so forth. In formulas (2) to (4), symbols A¹, B¹, A⁴, B⁴ and the like each surrounded by a hexagonal shape correspond to ring A¹, ring B¹, ring A⁴, ring B⁴ and the like, respectively. An amount of the compound expressed in terms of percentage is in a case of weight percentage (% by weight) based on a total amount of achiral component T or in a case of weight percentage (% by weight) based on a total amount of the composition.

Specific examples of “alkyl” herein include —CH₃, —C₂H₅, —C₃H₇, —C₄H₉, —C₅H₁₁, —C₆H₁₃, —C₇H₁₅, —C₈H₁₇, —C₉H₁₉, —C₁₀H₂₁, —C₁₁H₂₃, —C₁₂H₂₅, —C₁₃H₂₇, —C₁₄H₂₉ and —C₁₅H₃₁, and preferably include methyl, ethyl, propyl, butyl, pentyl, hexyl, heptyl or octyl, and further preferably include ethyl, propyl, butyl, pentyl or heptyl for decreasing viscosity.

Specific examples of “alkyl in which at least one hydrogen is replaced by halogen” herein include —CH₂F, —CHF₂, —CF₃, —(CH₂)₂—F, —CF₂CH₂F, —CF₂CHF₂, —CH₂CF₃, —CF₂CF₃, —(CH₂)₃—F, —(CF₂)₃—F, —CF₂CHFCF₃, —CHFCF₂CF₃, —(CH₂)₄—F, —(CF₂)₄—F, —(CH₂)₅—F and —(CF₂)₅—F.

Specific examples of “alkoxy” herein include —OCH₃, —OC₂H₅, —OC₃H₇, —OC₄H₉, —OC₅H₁₁, —OC₆H₁₃, —OC₇H₁₅, —OC₈H₁₇, —OC₉H₁₉, —OC₁₀H₂₁, —OC₁₁H₂₃, —OC₁₂H₂₅, —OC₁₃H₂₇ and —OC₁₄H₂₉, and preferably include methoxy, ethoxy, propoxy, butoxy, pentyloxy, hexyloxy or heptyloxy, and further preferably include methoxy or ethoxy for decreasing the viscosity.

Specific examples of “alkoxy in which at least one hydrogen is replaced by halogen” herein include —OCH₂F, —OCHF₂, —OCF₃, —O—(CH₂)₂—F, —OCF₂CH₂F, —OCF₂CHF₂, —OCH₂CF₃, —O—(CH₂)₃—F, —O—(CF₂)₃—F, —OCF₂CHFCF₃, —OCHFCF₂CF₃, —O(CH₂)₄—F, —O—(CF₂)₄—F, —O—(CH₂)₅—F and —O—(CF₂)₅—F.

Specific examples of “alkenyl” herein include —CH═CH₂, —CH═CHCH₃, —CH₂CH═CH₂, —CH═CHC₂H₅, —CH₂CH═CHCH₃, —(CH₂)₂—CH═CH₂, —CH═CHC₃H₇, —CH₂CH═CHC₂H₅, —(CH₂)₂—CH═CHCH₃ and —(CH₂)₃—CH═CH₂, and preferably include vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl, and further preferably include vinyl, 1-propenyl, 3-butenyl or 3-pentenyl for decreasing the viscosity.

Specific examples of “alkenyl in which at least one hydrogen is replaced by halogen” herein include —CH═CHF, —CH═CF₂, —CF═CHF, —CH═CHCH₂F, —CH═CHCF₃, —(CH₂)₂—CH═CF₂, —CH₂CH═CHCF₃, —CH═CHCF₃ and —CH═CHCF₂CF₃, and preferably include —CH═CF₂ and —(CH₂)₂—CH═CF₂ for decreasing the viscosity of the composition.

A preferred configuration of —CH═CH— in the alkenyl herein depends on a position of a double bond. In alkenyl having a double bond in an odd-numbered position, such as —CH═CHCH₃, —CH═CHC₂H₅, —CH═CHC₃H₇, —CH═CHC₄H₉, —C₂H₄CH═CHCH₃ and —C₂H₄CH═CHC₂H₅, a trans configuration is preferred. In alkenyl having the double bond in an even-numbered position, such as —CH₂CH═CHCH₃, —CH₂CH═CHC₂H₅ and —CH₂CH═CHC₃H₇, a cis configuration is preferred. An alkenyl compound having the preferred configuration has a high maximum temperature or a wide temperature range. A detailed description is found in Mol. Cryst. Liq. Cryst., 1985, 131, 109 and Mol. Cryst. Liq. Cryst., 1985, 131, 327.

Specific examples of “alkoxyalkyl” herein include —CH₂OCH₃, —CH₂OC₂H₅, —CH₂OC₃H₇, —(CH₂)₂—OCH₃, —(CH₂)₂—OC₂H₅, —(CH₂)₂—OC₃H₇, —(CH₂)₃—OCH₃, —(CH₂)₄—OCH₃ and —(CH₂)₅—OCH₃.

Specific examples of “alkenyloxy” herein include —OCH₂CH═CH₂, —OCH₂CH═CHCH₃ and —OCH₂CH═CHC₂H₅.

Specific examples of “alkynyl” herein include —C≡CH, —C≡C≡CH₃, —CH₂C≡CH, —C≡CC₂H₅, —CH₂C≡CCH₃, —(CH₂)₂—C≡CH, —C≡CC₃H₇, —CH₂C≡CC₂H₅, —(CH₂)₂—C≡CCH₃ and —C≡C(CH₂)₅.

Specific examples of “halogen” herein include fluorine, chlorine, bromine or iodine.

The liquid crystal composition of the disclosure is a composition that contains chiral component T and the chiral agent to develop the optically isotropic liquid crystal phase. In addition to achiral component T and the chiral agent, the liquid crystal composition of the disclosure may further contain a solvent, and a polymerizable monomer or the like (section 5-2-1 and section 5-2-2), a polymerization initiator (section 5-2-3), a curing agent (section 5-2-4), a curing promoter and a stabilizer (section 5-2-4) or the like to be described later.

### 1. Achiral Component T

Achiral component T contains at least one compound 1, at least one compound 2 and at least one compound 3.

An aspect of the liquid crystal composition of the disclosure is a composition containing compound 1, compound 2, compound 3, and any other component in which a component name is not particularly shown herein, and a composition containing compound 1, compound 2, compound 3 and compound 4, and any other component in which a component name is not particularly shown herein.

Achiral component T of the disclosure contains one kind of compound of compounds 1 to 4, or two or more kinds of compounds thereof in several cases. More specifically, the liquid crystal composition of the disclosure may contain a plurality of kinds of compounds 1 having mutually different structures represented by formula (1). A same rule applies also to compounds 2, 3 and 4.

### 1-1. Liquid Crystal Medium

### 1-1-1. Compound 1

The liquid crystal medium used in the device of the disclosure is a liquid crystal medium that develops the optically isotropic liquid crystal phase, for example, the blue phase. The liquid crystal medium used in the device of the disclosure contains at least one kind or two or more kinds of compounds represented by formula (1).

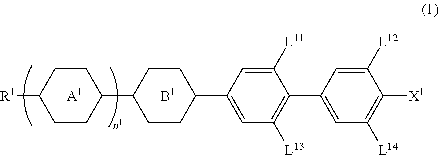

In formula (1), R¹ is hydrogen, alkyl having 1 to 20 carbons, alkenyl having 2 to 20 carbons, alkynyl having 2 to 20 carbons, alkoxy having 1 to 19 carbons, or alkoxyalkyl having 2 to 20 carbons in total, and in R¹, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R¹, a case where —O— and —CH═CH—, and —CO— and —CH═CH— are adjacent to each other is excluded;

ring A¹ and ring B¹ are independently 1,4-cyclohexylene, 1,4-phenylene, 2-fluoro-1,4-phenylene, 3-fluoro-1,4-phenylene, 3,5-difluoro-1,4-phenylene, pyridine-2,5-diyl, pyrimidine-2,5-diyl, 1,3-dioxane-2,5-diyl, or tetrahydropyran-2,5-diyl;

L¹¹ to L¹⁴ are independently hydrogen, fluorine or chlorine;

X¹ is hydrogen, halogen, —SF₅ or alkyl having 1 to 10 carbons, and in X¹, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in X¹, a case where —O— and —CH═CH—, and —CO— and —CH═CH— are adjacent to each other is excluded; and

n¹ is 1 or 2, and when n¹ is 2, a plurality of rings A¹ may be identical to or different from each other.

In formula (1), preferred R¹ is alkyl having 1 to 12 carbons, and further preferred R¹ is alkyl having 1 to 5 carbons.

In formula (1), preferred ring A¹ is 1,4-cyclohexylene or tetrahydropyran-2,5-diyl providing a wide liquid crystal phase and comparatively good compatibility with other compounds, 1,4-phenylene providing a low melting point and good compatibility with other compounds, 2-fluoro-1,4-phenylene, 3-fluoro-1,4-phenylene or 3,5-difluoro-1,4-phenylene providing large dielectric anisotropy and large refractive index anisotropy, pyridine-2,5-diyl or pyrimidine-2,5-diyl providing significantly large dielectric anisotropy and large refractive index anisotropy and 1,3-dioxane-2,5-diyl providing significantly large dielectric anisotropy. Particularly preferred ring A¹ is 1,4-cyclohexylene, 1,4-phenylene, 1,3-dioxane-2,5-diyl or tetrahydropyran-2,5-diyl.

In formula (1), preferred ring B¹ is 1,4-cyclohexylene or tetrahydropyran-2,5-diyl providing a wide liquid crystal phase and comparatively good compatibility with other compounds, 1,4-phenylene providing a low melting point and good compatibility with other compounds, 2-fluoro-1,4-phenylene, 3-fluoro-1,4-phenylene or 3,5-difluoro-1,4-phenylene providing large dielectric anisotropy and large refractive index anisotropy, pyridine-2,5-diyl or pyrimidine-2,5-diyl providing significantly large dielectric anisotropy and large refractive index anisotropy and 1,3-dioxane-2,5-diyl providing significantly large dielectric anisotropy. Particularly preferred ring B¹ is 1,4-phenylene, 2-fluoro-1,4-phenylene, 3-fluoro-1,4-phenylene and 3,5-difluoro-1,4-phenylene.

In formula (1), compound 1 in which L¹¹ to L¹⁴ are hydrogen has a high clearing point and good compatibility at a low temperature, and compound 1 in which L¹¹ to L¹⁴ are fluorine has a low melting point and significantly large dielectric anisotropy. Moreover, compound 1 in which L¹¹ to L¹⁴ are chlorine has a low melting point, large dielectric anisotropy and good compatibility with other compounds.

In formula (1), preferred X¹ is fluorine, —CF₃ or alkyl having 1 to 12 carbons, and further preferred X¹ is fluorine or alkyl having 1 to 12 carbons.

Achiral component T contains compound 1 in an amount of preferably about 1% by weight to about 30% by weight in total, further preferably about 3% by weight to about 25% by weight in total, and particularly preferably about 5% by weight to about 20% by weight in total, based on the total amount of achiral component T.

Compound 1 is significantly physically and chemically stable under conditions in which the device is ordinarily used, and compound 1 in which X¹ is fluorine, chlorine, —CF₃ or —OCF₃ has a high clearing point, large dielectric anisotropy and comparatively large refractive index anisotropy, and therefore such compound 1 is useful as a component for decreasing a driving voltage of the liquid crystal composition driven in the optically isotropic liquid crystal phase. Compound 1 in which X¹ is alkyl having 1 to 12 carbons or alkoxy having 1 to 11 carbons has a high clearing point and comparatively good compatibility with other compounds. A composition containing the compound is stable under conditions in which the device is ordinarily used. Accordingly, if compound 1 in the liquid crystal composition is used, a temperature range of the liquid crystal phase can be extended, and the resulting material can be used in the form of the display device in the wide temperature range. Further, reduction of an effective dielectric constant in a high frequency region is suppressed.

### 1-1-2. Compound 2

The liquid crystal medium used in the device of the disclosure may contain at least one kind or two or more kinds of compounds 2 represented by formula (2).

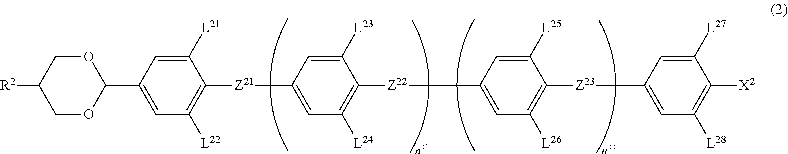

In formula (2), R² is hydrogen, alkyl having 1 to 20 carbons, alkenyl having 2 to 20 carbons, alkynyl having 2 to 20 carbons, alkoxy having 1 to 19 carbons or alkoxyalkyl having 2 to 20 carbons in total, and in R², at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R², a case where —O— and —CH═CH—, and —CO— and —CH═CH— are adjacent to each other is excluded;

Z²¹ to Z²³ are independently a single bond, —COO— or —CF₂O—, and at least one thereof is —COO— or —CF₂O—, and when n²¹ is 0 and n²² is 1, at least one of Z²¹ or Z²³ is —COO— or —CF₂O—, and when n²¹ is 1 and n²² is 0, at least one of Z²¹ or Z²² is —COO— or —CF₂O—;

L²¹ to L²⁸ are independently hydrogen or fluorine;

X² is hydrogen, halogen, —SF₅ or alkyl having 1 to 10 carbons, and in X², at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in X², a case where —O— and —CH═CH—, and —CO— and —CH═CH— are adjacent to each other is excluded; and

n²¹ and n²² are independently 0 or 1, and a sum of n²¹ and n²² is 1 or 2.

In formula (2), when R² is hydrogen, methyl or ethyl, such a compound contributes to a decrease in the driving voltage at a level higher than a compound in which R² is alkyl having 3 or more carbons. Moreover, a compound in which R² is methyl has a higher clearing point than a compound in which R² is hydrogen.

In formula (2), when X² is fluorine, chlorine, —SF₅, —CF₃, —OCF₃ or —CH═CH—CF₃, such a compound has large dielectric anisotropy. When X² is fluorine, —CF₃ or —OCF₃, such a compound is chemically stable. Specific examples of preferred X² include fluorine, chlorine, —CF₃, —CHF₂, —OCF₃ and —OCHF₂. Specific examples of further preferred X² include fluorine, chlorine, —CF₃ and —OCF₃. When X₂ is chlorine and fluorine, such a compound has a low melting point and particularly excellent compatibility with other liquid crystal compounds. When X² is —CF₃, —CHF₂, —OCF₃ and —OCHF₂, such a compound exhibits particularly large dielectric anisotropy.

The disclosure includes a case of containing one kind of compound as compound 2 in achiral component T, and also a case of containing two or more kinds of compounds as compound 2 therein.

Achiral component T contains compound 2 in an amount of preferably about 25% by weight to about 90% by weight in total, further preferably about 35% by weight to about 85% by weight in total, and particularly preferably about 45% by weight to about 80% by weight in total, based on the total amount of achiral component T.

Compound 2 is significantly physically and chemically stable under conditions in which the device is ordinarily used, and has comparatively good compatibility with other compounds. A composition containing the compound is stable under conditions in which the device is ordinarily used. Accordingly, if compound 2 is used in the liquid crystal composition, a temperature range of the optically isotropic liquid crystal phase can be extended, and the resulting material can be used in the form of the device in the wide temperature range.

Moreover, compound 2 has large dielectric anisotropy and comparatively large refractive index anisotropy, and therefore is useful as a component for decreasing the driving voltage of the liquid crystal composition driven in the optically isotropic liquid crystal phase.

### 1-1-3. Compound 3

The liquid crystal medium used in the device of the disclosure may contain at least one kind or two or more kinds of compounds 3 represented by formula (3).

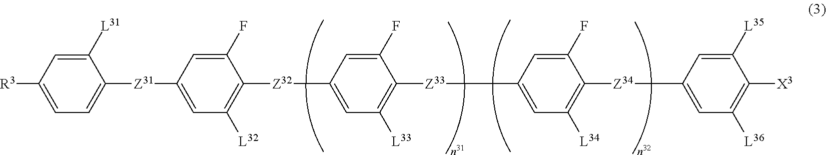

In formula (3), R³ is hydrogen, alkyl having 1 to 20 carbons, alkenyl having 2 to 20 carbons, alkynyl having 2 to 20 carbons, alkoxy having 1 to 19 carbons or alkoxyalkyl having 2 to 20 carbons in total, and at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R³, a case where —O— and —CH═CH—, and —CO— and —CH═CH— are adjacent to each other is excluded;

Z³¹ to Z³⁴ are independently a single bond, —COO— or —CF₂O—, and at least one piece thereof is —COO— or —CF₂O—, and when n³¹ is 0 and n³² is 1, at least one of Z³² or Z³⁴ is —COO— or —CF₂O—, and when n³¹ is 1 and n³² is 0, at least one of Z³² or Z³³ is —COO— or —CF₂O—;

L³¹ to L³⁶ are independently hydrogen or fluorine;

X³ is hydrogen, halogen, —SF₅ or alkyl having 1 to 10 carbons, and in X³, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in X³, a case where —O— and —CH═CH—, and —CO— and —CH═CH— are adjacent to each other is excluded; and

n³¹ and n³² are independently 0 or 1, and a sum of n³¹ and n³² is 1 or 2.

Compound 3 has 4 or 5 benzene rings, and has at least one of —COO— or —CF₂O— linking group. Compound 3 is significantly physically and chemically stable under conditions in which the device is ordinarily used, and has comparatively good compatibility with other compounds. A composition containing the compound is stable under conditions in which the device is ordinarily used. Accordingly, the temperature range of the nematic phase in the composition can be extended, and the composition can be used in the form of the display device in the wide temperature range. Moreover, the compound has large dielectric anisotropy and large refractive index anisotropy, and therefore is useful as a component for decreasing the driving voltage of the liquid crystal composition driven in the optically isotropic liquid crystal phase.

In formula (3), physical properties such as the clearing point, the refractive index anisotropy and the dielectric anisotropy can be arbitrarily adjusted by appropriately selecting R³, groups (L³¹ to L³⁶ and X³) on a benzene ring, or bonding groups Z³¹ to Z³⁴.

In formula (3), Z³¹ to Z³⁴ are independently a single bond, —COO— or —CF₂O—, but at least one thereof is —COO— or —CF₂O—. When Z³¹ to Z³⁴ are a single bond or —CF₂O—, viscosity is small, and when Z³¹ to Z³⁴ are —CF₂O—, the dielectric anisotropy is large. When Z³¹ to Z³⁴ are a single bond or —CF₂O—, such a compound is chemically comparatively stable, and is comparatively hard to cause deterioration.

In formula (3), L³¹ to L³⁶ are independently hydrogen or fluorine. When the number of fluorine is large in L³¹ to L³⁶, the dielectric anisotropy is large. When both L³⁵ and L³⁶ are fluorine, the dielectric anisotropy is particularly large.

In formula (3), X³ is hydrogen, halogen, —SF₅ or alkyl having 1 to 10 carbons, and at least one piece of —CH₂— in the alkyl may be replaced by —O—, —S—, —COO— or —OCO—, and in X³, at least one piece of —CH₂—CH₂— may be replaced by —CH═CH—, —CF═CF— or —C≡C—, and at least one hydrogen may be replaced by fluorine or chlorine.

In formula (3), preferred X³ is fluorine, chlorine, —CF₃, —CHF₂, —OCF₃ and —OCHF₂, and further preferred X³ is fluorine, chlorine, —CF₃ and —OCF₃.

In formula (3), when X³ is fluorine, chlorine, —SF₅, —CF₃, —CHF₂, —CH₂F, —OCF₃, —OCHF₂ or —OCH₂F, such a compound has large dielectric anisotropy. When X³ is fluorine, —OCF₃ or —CF₃, such a compound is chemically stable.

The disclosure includes a case of containing one kind of compound as compound 3 in achiral component T, and also a case of containing two or more kinds of compounds as compound 3 therein.

Achiral component T contains compound 3 in an amount of preferably about 5% by weight to about 65% by weight in total, further preferably about 10% by weight to about 60% by weight in total, and particularly preferably about 15% by weight to about 55% by weight in total, based on the total amount of achiral component T.

Compound 3 is significantly physically and chemically stable under conditions in which the device is ordinarily used, and has comparatively good compatibility with other compounds. A composition containing the compound is stable under conditions in which the device is ordinarily used. Accordingly, if compound 3 is used in the liquid crystal composition, the temperature range of the optically isotropic liquid crystal phase can be extended, and the resulting material can be used as the device in the wide temperature range.

Moreover, compound 3 has comparatively large dielectric anisotropy and large refractive index anisotropy, and therefore is useful as a component for decreasing the driving voltage of the liquid crystal composition driven in the optically isotropic liquid crystal phase.

### 1-1-4. Compound 4

The liquid crystal medium used in the device of the disclosure may further contain at least one kind or two or more kinds of compounds 4 represented by formula (4).

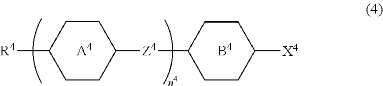

In formula (4), R⁴ is hydrogen, alkyl having 1 to 20 carbons, alkenyl having 2 to 20 carbons, alkynyl having 2 to 20 carbons, alkoxy having 1 to 19 carbons or alkoxyalkyl having 2 to 20 carbons in total, and in R⁴, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R⁴, a case where —O— and —CH═CH—, and —CO— and —CH═CH— are adjacent to each other is excluded;

ring A⁴ and ring B⁴ are independently 1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl;

Z⁴ is a single bond, —O—, —COO—, —CH₂CH₂—, —CH₂O—, —CF₂O—, —CH═CH—, —CF═CF— and —C≡C—;

X⁴ is hydrogen, halogen, —SF₅ or alkyl having 1 to 10 carbons, and in X⁴, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in X⁴, a case where —O— and —CH═CH—, and —CO— and —CH═CH— are adjacent to each other is excluded; and

n⁴ is 1 or 2, and when n⁴ is 2, a plurality of rings A⁴ and Z⁴ may be identical to or different from each other.

In formula (4), preferred R⁴ is hydrogen, alkyl having 1 to 12 carbons, alkenyl having 2 to 12 carbons, alkynyl having 2 to 12 carbons or alkoxy having 1 to 11 carbons.

In formula (4), from a viewpoint of stability and a wide liquid crystal temperature range of the compound, preferred ring A⁴ or ring B⁴ is independently 1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl.

In formula (4), preferred Z⁴ is a single bond, —O—, —COO—, —CH₂CH₂—, —CH₂O— and —CF₂O—, and is a single bond for the wide liquid crystal temperature range and low viscosity, and is —CF₂O— for large dielectric anisotropy.

In formula (4), preferred X⁴ is fluorine, chlorine, —CF₃, —OCF₃, alkyl having 1 to 12 carbons, alkenyl having 2 to 12 carbons or alkoxy having 1 to 11 carbons, and further preferred X⁴ is fluorine for comparatively large dielectric anisotropy, and alkyl having 1 to 12 carbons, alkenyl having 2 to 12 carbons or alkoxy having 1 to 11 carbons for low viscosity.

In formula (4), a material in which n⁴=1 is preferred for a low melting point and small viscosity, and a material in which n⁴=2 is preferred for a comparatively high maximum temperature.

Achiral component T contains compound 4 in an amount of preferably about 0% by weight to about 40% by weight in total, further preferably about 3% by weight to about 30% by weight in total, and particularly preferably about 5% by weight to about 20% by weight in total, based on the total amount of achiral component T.

Compound 4 is significantly physically and chemically stable under conditions in which the device is ordinarily used, and a material in which X⁴ is fluorine, chlorine, —CF₃ or —OCF₃ has a high clearing point, and large dielectric anisotropy and comparatively large refractive index anisotropy, and therefore such compound 4 is useful as a component for decreasing the driving voltage of the liquid crystal composition driven in the optically isotropic liquid crystal phase. A material in which X⁴ is alkyl having 1 to 12 carbons, alkenyl having 2 to 12 carbons or alkoxy having 1 to 11 carbons has a high clearing point and comparatively good compatibility with other compounds. A composition containing the compound is stable under conditions in which the device is ordinarily used. Accordingly, if compound 4 is used in the liquid crystal composition, the temperature range of the liquid crystal phase can be extended, and the resulting material can be used in the form of the display device in the wide temperature range.

### 1-1-5. Synthesis of Compounds 1 to 4

Compounds 1 to 4 can be prepared by appropriately combining techniques in synthetic organic chemistry. Methods for introducing an objective terminal group, ring and bonding group into a starting material are described in “Organic Syntheses” (John Wiley & Sons, Inc.), “Organic Reactions” (John Wiley & Sons, Inc.), “Comprehensive Organic Synthesis” (Pergamon Press), “New Experimental Chemistry Course (Shin Jikken Kagaku Koza in Japanese)” (Maruzen Co., Ltd.) and so forth.

Compounds 1 to 4 can be prepared also by applying mutatis mutandis the method described in JP 2959526 B, for example.

### 2. Chiral Agent

The chiral agent contained in the optically isotropic liquid crystal composition is an optically active compound, and is preferably composed of a compound selected from compounds having no radical polymerization group.

As the chiral agent used in the composition of the disclosure, a compound having large helical twisting power is preferred. In the compound having the large helical twisting power, an amount of addition required for obtaining a desired pitch can be decreased, and therefore a rise of the driving voltage can be suppressed, and such a case is practically advantageous. Specifically, the chiral agent described in WO 2018/003658 A is preferred.

In order to set a desired pitch length, a chiral agent having a polymerizable group, or a chiral agent causing photoisomerization may be used. As the chiral agent to be incorporated into the liquid crystal composition, one compound may be used, or two or more kinds of compounds may be used.

In order to facilitate to develop the optically isotropic liquid crystal phase, the liquid crystal composition of the disclosure contains the chiral agent in an amount of preferably about 0.5% by weight to about 40% by weight, further preferably about 1% by weight to about 25% by weight, and particularly preferably about 2% by weight to about 15% by weight, based on a total amount of the liquid crystal composition.

### 3. Optically Isotropic Liquid Crystal Phase

The expression “liquid crystal composition has optical isotropy” herein means that the liquid crystal composition exhibits the optical isotropy macroscopically because arrangement of liquid crystal molecules is isotropic, in which liquid crystal order is microscopically present. A “pitch based on the liquid crystal order of the liquid crystal composition microscopically (hereinafter, occasionally referred to as a pitch)” is preferably about 700 nanometers or less, further preferably about 500 nanometers or less, and most preferably about 350 nanometers or less.

A temperature range in which the liquid crystal composition of a preferred aspect of the disclosure develops the optically isotropic liquid crystal phase can be extended by adding the chiral agent to the liquid crystal composition in which a coexisting temperature range between the nematic phase or a chiral nematic phase and an isotropic phase is wide to develop the optically isotropic liquid crystal phase. For example, a liquid crystal compound having a high clearing point is mixed with a liquid crystal compound having a low clearing point to prepare a liquid crystal composition in which the coexisting temperature range between the nematic phase and the isotropic phase is wide in the wide temperature range, and adding the chiral agent thereto, whereby the composition that develops the optically isotropic liquid crystal phase in the wide temperature range can be prepared.

As the liquid crystal composition in which the coexisting temperature range between the nematic phase or the chiral nematic phase and the isotropic phase is wide, a liquid crystal composition in which a difference between a maximum temperature and a minimum temperature at which the chiral nematic phase and a non-liquid crystal isotropic phase coexist is about 3 to about 150° C. is preferred, and a liquid crystal composition in which the difference is about 5 to about 150° C. is further preferred. Moreover, a liquid crystal composition in which the difference between the maximum temperature and the minimum temperature at which the nematic phase and the non-liquid crystal isotropic phase coexist is about 3 to about 150° C. is preferred.

### 4. Other Components

The optically isotropic liquid crystal composition of the disclosure may further contain a solvent, a polymer substance, a dichroic dye, a photochromic compound or the like in a range in which a large influence is not produced on characteristics of the composition.

Moreover, specific examples of the dichroic dye used in the liquid crystal composition of the disclosure include a merocyanine dye, a styryl dye, an azo dye, an azomethine dye, an azoxy dye, a quinophthalone dye, an anthraquinone dye and a tetrazine dye.

### 5. Optically Isotropic Polymer/Liquid Crystal Composite Material

An optically isotropic polymer/liquid crystal composite material of the disclosure can also be produced by mixing the optically isotropic liquid crystal composition with a polymer obtained by previously polymerizing a monomer, but is preferably produced by producing a mixture of a monomer, a macromonomer, an oligomer and the like each having low molecular weight to be a material of the polymer (hereinafter, collectively referred to as a “polymerizable monomer or the like”) and the liquid crystal composition, and then performing a polymerization reaction in the mixture.

### 5-1. Polymer/Liquid Crystal Composite Material

The polymer/liquid crystal composite material of the disclosure is a composite material that contains the liquid crystal composition and the polymer to exhibit the optical isotropy, and can be used in the optical switching device driven in the optically isotropic liquid crystal phase. The liquid crystal composition contained in the polymer/liquid crystal composite material of the disclosure is the liquid crystal composition of the disclosure.

The “polymer/liquid crystal composite material” herein is not particularly limited, as long as the composite material containing both the liquid crystal composition and a polymer compound is applied, and may be in a state in which the polymer is phase-separated from the liquid crystal composition in a state in which the polymer is not dissolved partly or wholly in the liquid crystal composition. In addition, unless otherwise noted, the nematic phase herein means the nematic phase in a narrow sense without including the chiral nematic phase.

The optically isotropic polymer/liquid crystal composite material according to a preferred aspect of the disclosure can develop the optically isotropic liquid crystal phase in the wide temperature range. Moreover, the optically isotropic polymer/liquid crystal composite material according to the preferred aspect of the disclosure has a significantly high response speed. Moreover, the optically isotropic polymer/liquid crystal composite material according to the preferred aspect of the disclosure can be preferably used in the optical switching device based on the effects.

### 5-2. Mixture Containing a Liquid Crystal Composition and a Polymerizable Monomer or the Like

A mixture containing the polymerizable monomer or the like and the liquid crystal composition is referred to as a “polymerizable monomer/liquid crystal mixture” herein. The “polymerizable monomer/liquid crystal mixture” may contain a polymerization initiator (section 5-2-3), a curing agent (section 5-2-4), a curing promoter (section 5-2-4), a stabilizer (section 5-2-4), a dichroic dye, a photochromic compound or the like as described later, when necessary, in the range in which advantageous effects of the disclosure are not adversely affected. For example, the polymerizable monomer/liquid crystal mixture of the disclosure may contain about 0.1 to about 20 parts by weight of the polymerization initiator based on 100 parts by weight of the polymerizable monomer, when necessary. The “polymerizable monomer/liquid crystal mixture” is essentially the liquid crystal medium when the mixture is polymerized at a temperature at which the mixture develops the blue phase, but is not necessarily the liquid crystal medium when the mixture is polymerized at a temperature at which the mixture becomes the isotropic phase.

A polymerization temperature is preferably a temperature at which the polymer/liquid crystal composite material exhibits high transparency and isotropy. Polymerization is further preferably terminated at a temperature at which the mixture of the polymerizable monomer or the like and the liquid crystal composition develops the isotropic phase or the blue phase, and at a temperature at which the mixture results in the isotropic phase or the optically isotropic liquid crystal phase. More specifically, after polymerization, the temperature is preferably adjusted to a temperature at which the polymer/liquid crystal composite material does not substantially scatter light on a side of a wavelength longer than the wavelength of visible light and develops an optically isotropic state.

As a raw material of the polymer constituting the composite material of the disclosure, for example, a monomer, a macromonomer or an oligomer each having low molecular weight can be used, and a term “raw material monomer of the polymer” herein is used in the meaning of involving the monomer, the macromonomer, the oligomer and the like each having low molecular weight. Moreover, a material from which the polymer to be obtained has a three-dimensional crosslinking structure is preferred, and therefore a polyfunctional monomer having two or more polymerizable functional groups is preferably used as the raw material monomer of the polymer. The polymerizable functional group is not particularly limited, and specific examples thereof include an acrylic group, a methacrylic group, a glycidyl group, an epoxy group, an oxetanyl group and a vinyl group. From a viewpoint of a polymerization rate, an acrylic group and a methacrylic group are preferred. Among the raw material monomers of the polymer, if about 10% by weight or more of the monomer having two or more polymerizable functional groups is incorporated into the monomer, high transparency and isotropy are easily developed in the composite material of the disclosure, and therefore such a case is preferred.

Moreover, in order to obtain a preferred composite material, the polymer is preferably a material having a mesogen site, and as the raw material monomer of the polymer, the raw material monomer having the mesogen site can be partly or wholly used therefor.

In order to obtain a further preferred composite material, a monofunctional or polyfunctional monomer having the mesogen site and a monomer having a polymerizable functional group with no mesogen site can be simultaneously used therefor. Moreover, a polymerizable compound other than the monofunctional or polyfunctional monomer having the mesogen site and the monomer having the polymerizable functional group with no mesogen site can be used, when necessary.

### 5-2-1. Monofunctional or Polyfunctional Monomer Having a Mesogen Site

The monofunctional or bifunctional monomer having the mesogen site is not particularly limited structurally, and specific examples thereof include the monofunctional or bifunctional monomer having the mesogen site described in WO 2018/003658 A.

5-2-2. Monomer Having a Polymerizable Functional Group with No Mesogen Site

Specific examples of the monomer having the polymerizable functional group with no mesogen site include the monomer having the polymerizable functional group with no mesogen site described in WO 2018/003658 A.

### 5-2-3. Polymerization Initiator

The polymerization reaction in production of the polymer constituting the composite material of the disclosure is not particularly limited, and photoradical polymerization, thermal radical polymerization, photocationic polymerization or the like is performed, for example. Specific examples thereof include the polymerization initiator described in WO 2018/003658 A.

### 5-2-4. Curing Agent or the Like

In production of the polymer constituting the composite material of the disclosure, in addition to the polymerizable monomer or the like and the polymerization initiator, one or two or more other preferred components, for example, a curing agent, a curing promoter, a stabilizer or the like may be further added thereto. Specific examples thereof include the curing agent or the like described in WO 2018/003658 A.

### 5-4. Composition of a Polymer/Liquid Crystal Composite Material

A content of the liquid crystal composition in the polymer/liquid crystal composite material of the disclosure is preferably as high as possible, as long as the content is in the range in which the composite material can develop the optically isotropic liquid crystal phase. The reason is that, as the content of the liquid crystal composition is higher, an electric birefringence value of the composite material of the disclosure increases.

In the polymer/liquid crystal composite material of the disclosure, a content of the liquid crystal composition is preferably about 60% by weight to about 99% by weight, further preferably about 60% by weight to about 98% by weight, and particularly preferably about 80% by weight to about 97% by weight, based on the composite material. Moreover, in the polymer/liquid crystal composite material of the disclosure, a content of the polymer is preferably about 1% by weight to about 40% by weight, further preferably about 2% by weight to about 40% by weight, and particularly preferably about 3% by weight to about 20% by weight, based on the composite material.

### 6. Optical Switching Device

Although operation will be described in detail in Examples described later, as a device for applying voltage in a direction perpendicular to an electrode surface, a polymer/liquid crystal composite material was interposed between two glass substrates with electrodes subjected to no alignment treatment, and a cell obtained was heated to a blue phase. In the state, the cell was irradiated with ultraviolet light to perform a polymerization reaction. An optically isotropic liquid crystal phase was maintained even if the polymer/liquid crystal composite material thus obtained was cooled to room temperature. The cell in which the polymer/liquid crystal composite material was interposed therebetween was used as an optical switching device.

### EXAMPLES

Hereinafter, the disclosure will be described in more detail by way of Examples, but the disclosure is not limited by the Examples. In addition, unless otherwise noted, a symbol “%” means “% by weight.”

In the disclosure, characteristic values of a liquid crystal composition can be measured according to methods described below. Many of the methods are the methods described in Standard of Electronic Industries Association of Japan, EIAJ ED-2521A, or methods modified therefrom. TFT was not attached to a TN device used for measurement.

### Maximum Temperature of Nematic Phase (NI; ° C.):

A sample was placed on a hot plate of a melting point measuring device equipped with a polarized-light microscope (large-sized sample cooling and heating stage, made by LINKAM Scientific Instruments, Ltd.), and was observed with the polarized-light microscope while heating the sample at a rate of 1° C./min. A temperature when a part of the sample was changed from a nematic phase to an isotropic liquid was taken as a maximum temperature of the nematic phase. Hereinafter, the maximum temperature of the nematic phase may be occasionally abbreviated as “maximum temperature.”

### Minimum Temperature of Nematic Phase (TC; ° C.):

Samples each having a nematic phase were put in glass vials, and the glass vials were kept in freezers at temperatures of 0° C., −10° C., −20° C., −30° C. and −40° C. for 10 days, and then liquid crystal phases were observed. For example, when the sample was maintained in the nematic phase at −20° C. and changed to crystals (or a smectic phase) at −30° C., TC was expressed as −20° C. A minimum temperature of the nematic phase may be occasionally abbreviated as “minimum temperature.”

### Transition Temperature of an Optically Isotropic Liquid Crystal Phase (N*−BP; ° C.):

A sample was placed on a hot plate of a melting point measuring device equipped with a polarized-light microscope (large-sized sample cooling and heating stage, made by LINKAM Scientific Instruments, Ltd.), and in a crossed nicol state, first, a temperature was increased to a temperature at which the sample became a non-liquid crystal isotropic phase, and then decreased at a rate of 10° C./min to completely emerge a chiral nematic phase or an optically isotropic liquid crystal phase in the sample. A temperature at which phase transition was caused in a temperature decreasing process was measured, and then a temperature was increased at a rate of 1° C./min, and a temperature at which phase transition was caused in a temperature increasing process was measured. In the disclosure, unless otherwise noted, the temperature at which phase transition was caused in the temperature increasing process was taken as a phase transition temperature. When distinguishing of the phase transition temperature is difficult in a dark field under the crossed nicol in the optically isotropic liquid crystal phase, a polarizing plate was shifted from the crossed nicol state by 1 to 10°, and the phase transition temperature was measured.

With regard to an expression of the transition temperature, crystals were expressed by K, and when the crystals can be distinguished, the transition temperature was each expressed by K1 or K2. Moreover, a smectic phase, a nematic phase and a chiral nematic phase were expressed by Sm, N and N*, respectively. An isotropic liquid was expressed by I. In the smectic phase, when a smectic B phase or a smectic A phase can be distinguished, the smectic B phase and the smectic A phase were expressed by SmB and SmA, respectively. BP expresses the blue phase or the optically isotropic liquid crystal phase. A coexistence state of two phases may be occasionally expressed by a form of (N*+I) or (N*+BP). Specifically, (N*+I) expresses a phase in which the non-liquid crystal isotropic phase and the chiral nematic phase coexist, and (N*+BP) expresses a phase in which the BP phase or the optically isotropic liquid crystal phase and the chiral nematic phase coexist. Un expresses an unidentified phase that is not optically isotropic. As an expression of the phase transition temperature, for example, the expression “K 50.0 N 100.0 I” represents that the phase transition temperature from crystals to the nematic phase is 50.0° C., and the phase transition temperature from the nematic phase to the liquid is 100.0° C. Moreover, the expression “BP-I” represents that the phase transition temperature from the blue phase or the optically isotropic liquid crystal phase to the isotropic liquid cannot be judged, and the expression “N 83.0 to 83.4 I” represents that the phase transition temperature from the nematic phase to the isotropic liquid has a width from 83.0° C. to 83.4° C. A same rule applies also to other expressions.

Viscosity (η; Measured at 20° C.; mPa·s):

Viscosity was measured using a cone-plate (E type) viscometer.

### Refractive Index Anisotropy (Δn; Measured at 25° C.):

Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was in parallel to a direction of rubbing. A refractive index (n⊥) was measured when the direction of polarized light was perpendicular to the direction of rubbing. A value of optical anisotropy was calculated from an equation: Δn=n∥−n⊥. When the sample was a composition, refractive index anisotropy was measured by the method described above.

### Dielectric Anisotropy (Δε; Measured at 25° C.):

A sample was put in a liquid crystal cell in which a distance (gap) between two glass substrates was about 9 micrometers and a twist angle was 80 degrees. A voltage of 20 V was applied to the cell and a dielectric constant (ε∥) in a major axis direction of liquid crystal molecules was measured. A voltage of 0.5 V was applied and a dielectric constant (ε⊥) in a minor axis direction of liquid crystal molecules was measured. A value of dielectric anisotropy was calculated from an equation: Δε=ε∥−ε⊥.

### Voltage Holding Ratio (VHR; Measured at 25° C.; %):

A TN device used for measurement had a polyimide alignment film, and a distance (cell gap) between two glass substrates was 6 micrometers. A sample was put in the device, and then the device was sealed with an ultraviolet-polymerizable adhesive. A pulse voltage (60 microseconds at 5 V) was applied to the TN device and the device was charged. A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

### Selective Reflection Wavelength (λ; Measured at 25° C.; Nm):

A selective reflection wavelength λ was measured with a microspectrophotometer (JEOL Co., Ltd., trade name MSV-350). A pitch of cholesteric liquid crystals having a reflection wavelength in a region of a wavelength longer or shorter than the wavelength of visible light is proportional to a reciprocal of a concentration of an optically active compound in a region in which the concentration of the optically active compound is low, and therefore the selective reflection wavelength was determined according to a linear extrapolation method by measuring pitch lengths of the liquid crystals having a selective reflection wavelength in a visible light region in several points. Specifically, a chiral compound was added at such a concentration as having the selective reflection wavelength in the visible light region (concentration C′) to measure selective reflection wavelength λ′, and an original selective reflection wavelength λ was calculated from an original chiral concentration (concentration C) according to the linear extrapolation method (λ=λ′×C′/C).

### Pitch Length (25° C.; nm):

The pitch length was calculated using the selective reflection wavelength λ (Handbook of Liquid Crystals (Ekisho Binran in Japanese), page 196, published in 2000, Maruzen Co., Ltd.). In the selective reflection wavelength λ, the following relational equation: <n>p/λ=1 holds. Here, <n> represents a mean refractive index, and is given by the following equation: <n>={(n_{∥}²+n_{⊥}²)/2}^{1/2}.

Helical Twist Power (HTP; 25° C.; μm⁻¹):

Helical twist power (HTP) was determined using mean refractive index <n> and the value of pitch length determined by the method described above, according to the following equation: HTP=<n>/(λ·C). Here, λ represents a selective reflection wavelength (nm) and C represents a chiral concentration (wt %).

Peak Top Measurement of a Dielectric Dissipation Factor Curve (Measured at a Temperature of −50° C. from a BP−I Transition Temperature):

A polymer stabilized blue phase (PSBP) was prepared in a cell in which a distance between two glass substrates (d; gap) was about 10 micrometers and an electrode area (S) with ITO electrodes was about 0.16 cm², and the resulting material was taken as a liquid crystal display device. An LCR meter (made by Agilent Technologies: E4980A) was used to apply a voltage of 10 V to the device, and capacitance (C) and tangent of loss angle (tan δ) were measured at a frequency of 20 to 2 MHz. The measured capacitance (C) was substituted to an equation: ε′=(C×d)/(ε₀×S), and dielectric constant ε′ was derived therefrom, and dielectric dissipation factor ε″ was derived from an equation: ε″=ε′×tan δ. Here, ε₀ is a dielectric constant of vacuum, and a value is 8.854 (pF/m). In a graph in which dielectric dissipation factor ε″′ thus determined is taken as a horizontal axis, and the frequency is taken as a vertical axis, when dielectric relaxation is present in a range of the frequency for measurement, a peak may be occasionally confirmed. Frequency dependence of dielectric dissipation factor ε″ correlated with frequency dependence of dielectric constant ε′, and a peak top of the dielectric dissipation factor curve is measured, whereby the measured value serves as an index of reduction of the effective dielectric constant at a high frequency. The peak top of the dielectric dissipation factor curve is located preferably at a high frequency for securing the effective dielectric constant, further preferably at a frequency higher than 10 KHz, and still further preferably at a frequency higher than 20 kHz. In addition, as a temperature of measuring the peak top of the dielectric dissipation factor curve, the peak top was measured at a temperature lower by 50° C. than a temperature at which the polymer/liquid crystal composite material undergoes phase transition from the blue phase to the isotropic liquid.

The compounds in Examples were represented using symbols according to definitions in Table 1 described below. Parenthesized numbers described after the symbols in Table 1 represent formulas to which the compounds belong. A symbol (−) means any other liquid crystal compound. A proportion (percentage) of the liquid crystal compound is expressed in terms of weight percent (% by weight) based on the weight of the liquid crystal composition. Values of the characteristics of the composition were summarized in a last part.

TABLE 1
Method for description of compounds using symbols
R-(A₁)-Z₁- . . . -Zₙ-(Aₙ)-R′

| 1) Left-terminal group R- | Symbol |
|---|---|
| CₙH2ₙ₊₁— | n- |
| CₙH2ₙ₊₁O— | nO— |
| CₘH₂ₘ₊₁OCₙH₂ₙ— | mOn- |
| CH₂═CH— | V— |
| CₙH₂ₙ₊₁—CH═CH— | nV— |
| CH₂═CH—CₙH₂ₙ— | Vn- |
| CₘH₂ₘ₊₁—CH═CH—CₙH₂ₙ— | mVn- |
| CF₂═CH— | VFF— |
| CF₂═CH—CₙH₂ₙ— | VFFn- |
| H— | H— |
| 2) Right-terminal group -R′ | Symbol |
| —CₙH₂ₙ₊₁ | -n |
| —CₙH₂ₙ₊₁ | —On |
| —CH═CH₂ | —V |
| —CH═CH—CₙH₂ₙ₊₁ | —Vn |
| —CₙH₂ₙ—CH═CH₂ | -nV |
| —CₙH₂ₙ—CH═CH—CₘH₂ₘ₊₁ | -nVm |
| —CH═CF₂ | —VFF |
| —COOCH₃ | -EMe |
| —F | —F |
| —Cl | —CL |
| —OCF₃ | —OCF₃ |
| —CF₃ | —CF₃ |
| —CN | —C |
| —OCH═CH—CF₂H | —OVCF2H |
| —OCH═CH—CF₃ | —OVCF3 |
| 3) Bonding group -Zₙ- | Symbol |
| —C₂H₄— | 2 |
| —COO— | E |
| —CH═CH— | V |
| —C≡C— | T |
| —CF₂O— | X |
| —CH₂O— | 1O |
| —O— | O |
| 4) Ring structure -An- | Symbol |
| 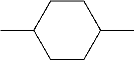 | H |
| 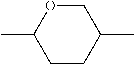 | Dh |
| 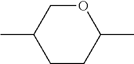 | dh |
| 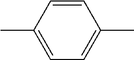 | B |
| 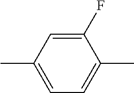 | B(F) |
| 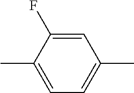 | B(2F) |
| 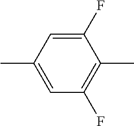 | B(F,F) |
| 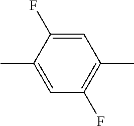 | B(2F,5F) |
| 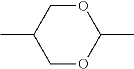 | G |
| 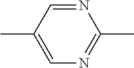 | Py |

5) Examples of description
Example 1 5-HBB(F)B-2

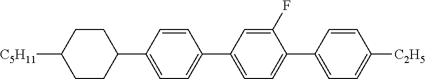

Example 2 3-GB(F,F)XB(F)B(F,F)-F

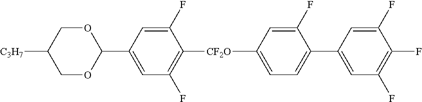

Example 3 4-B(F)B(F,F)B(F,F)XB(F,F)-CF3

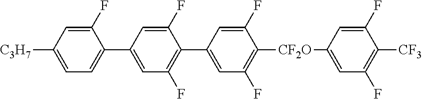

### Example 1

Liquid crystal composition NLC-A was prepared by mixing liquid crystal compounds shown in a diagram below at a proportion below.

### Liquid Crystal Composition NLC-A

| | | |
|---|---|---|
| 5-HBB(F)B-2 | (1) | 10% |
| 3-GB(F)B(F,F)XB(F,F)-F | (2) | 11.7% |
| 4-GB(F)B(F,F)XB(F,F)-F | (2) | 10.8% |
| 5-GB(F)B(F,F)XB(F,F)-F | (2) | 10.8% |
| 2-GB(F,F)XB(F)B(F,F)-F | (2) | 16.2% |
| 3-GB(F,F)XB(F)B(F,F)-F | (2) | 16.2% |
| 4-B(F)B(F,F)B(F,F)XB(F,F)-F | (3) | 6.3% |
| 5-B(F)B(F,F)B(F,F)XB(F,F)-F | (3) | 6.3% |
| 6-B(F)B(F,F)B(F,F)XB(F,F)-F | (3) | 6.3% |
| 3-B(F)B(F,F)B(F,F)XB(F,F)-CF3 | (3) | 2.7% |
| 4-B(F)B(F,F)B(F,F)XB(F,F)-CF3 | (3) | 2.7% |

A maximum temperature (° C.) of liquid crystal composition NLC-A was 112.8 to 117.0.

Next, liquid crystal composition CLC-A composed of liquid crystal composition NLC-A (95.0% by weight) and chiral agent (8H)BN−H5 (5.0% by weight) was obtained.

A phase transition temperature (° C.) of liquid crystal composition CLC-A was N*103.4 to 104.7 BP−BP+I−I.

A chemical structural formula of chiral agent (8H)BN−H5 is as described below.

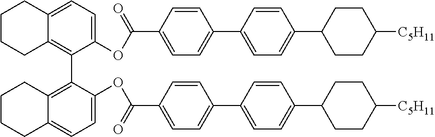

### Preparation of a Mixture (MLC-A) of a Polymerizable Monomer and a Liquid Crystal Composition

As a mixture of a liquid crystal composition and a polymerizable monomer, mixture MLC-A was prepared, in which 87.9% by weight of liquid crystal composition CLC-A, 6.5% by weight of n-hexadecyl acrylate, 5.2% by weight of 1,4-di(4-(6-acryloyloxy)-2-methylbenzene (LCA-1) and 0.4% by weight of 2,2′-dimethoxyphenylacetophenone as a photopolymerization initiator were mixed. A phase transition temperature (° C.) of mixture MLC-A was N*69.6 to 69.9 BP−BP+I−I.

A chemical structural formula of LCA-1 is as described below.

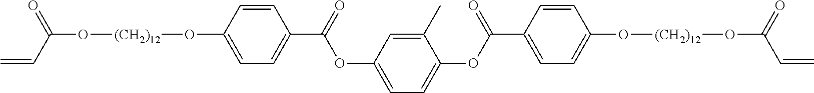

### Preparation of a Polymer/Liquid Crystal Composite Material (PSBP-A)

Mixture MLC-A was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 23 mWcm⁻² (365 nm)) for 1 minute to perform a polymerization reaction. A phase transition temperature (° C.) of the polymer/liquid crystal composite material (PSBP-A) thus obtained was BP 99.0 BP+I−I, and an optically isotropic liquid crystal phase was maintained even if the resulting material was cooled to room temperature. A peak top of a dielectric dissipation factor was located at 50 kHz, and a material capable of securing an effective dielectric constant in a high frequency region was obtained.

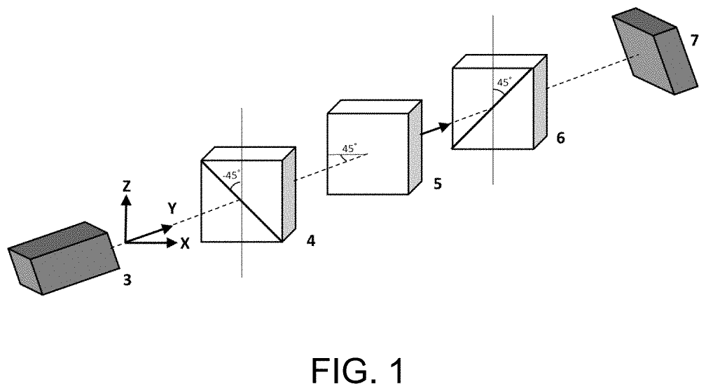

The cell in which polymer/liquid crystal composite material PSBP-A was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 2

Liquid crystal composition NLC-B was prepared by mixing liquid crystal compounds shown in a diagram below at a proportion below.

### Liquid Crystal Composition NLC-B

| | | |
|---|---|---|
| 5-HBB(F)B-2 | (1) | 14% |
| 3-GB(F)B(F,F)XB(F,F)-F | (2) | 4% |
| 4-GB(F)B(F,F)XB(F,F)-F | (2) | 4% |
| 5-GB(F)B(F,F)XB(F,F)-F | (2) | 4% |
| 1-GB(F,F)XB(F)B(F,F)-F | (2) | 5% |
| 2-GB(F,F)XB(F)B(F,F)-F | (2) | 18% |
| 3-GB(F,F)XB(F)B(F,F)-F | (2) | 18% |
| 4-GB(F,F)XB(F)B(F,F)-F | (2) | 12% |
| 4-B(F)B(F,F)B(F,F)XB(F,F)-F | (3) | 2% |
| 5-B(F)B(F,F)B(F,F)XB(F,F)-F | (3) | 2% |
| 6-B(F)B(F,F)B(F,F)XB(F,F)-F | (3) | 2% |
| 3-B(F)B(F,F)B(F,F)XB(F,F)-CF3 | (3) | 2.5% |
| 4-B(F)B(F,F)B(F,F)XB(F,F)-CF3 | (3) | 2.5% |
| 5-B(F)B(F,F)B(F,F)XB(F,F)-CF3 | (3) | 2.5% |
| 6-B(F)B(F,F)B(F,F)XB(F,F)-CF3 | (3) | 2.5% |
| H-BOB-F | (4) | 5% |

A maximum temperature (° C.) of liquid crystal composition NLC-B was 84.2 to 87.5.

Next, liquid crystal composition CLC-B composed of liquid crystal composition NLC-B (95.0% by weight) and chiral agent (8H)BN-H5 (5.0% by weight) was obtained.

A phase transition temperature (° C.) of liquid crystal composition CLC-B was N*77.8 to 79.1 BP−BP+I+I 88.3 I.

### Preparation of a Mixture (MLC-B) of a Polymerizable Monomer and a Liquid Crystal Composition

As a mixture of a liquid crystal composition and a polymerizable monomer, mixture MLC-B was prepared, in which 87.9% by weight of liquid crystal composition CLC-B, 6.5% by weight of n-hexadecyl acrylate, 5.2% by weight of benzene-1,2,4-triyltris(4-(12-(acryloyloxy)dodecyloxy)benzoyloxy)benzoate (LCA-2) and 0.4% by weight of 2,2′-dimethoxyphenylacetophenone as a photopolymerization initiator were mixed. A phase transition temperature (° C.) of mixture MLC-B was N*48.6 to 49.4 BP−BP+I−I.

A chemical structural formula of LCA-2 is as described below.

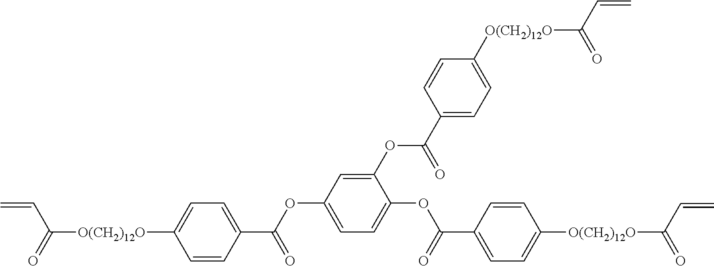

### Preparation of a Polymer/Liquid Crystal Composite Material (PSBP-B)

Mixture MLC-B was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 23 mWcm⁻² (365 nm)) for 1 minute to perform a polymerization reaction. A phase transition temperature (° C.) of the polymer/liquid crystal composite material (PSBP-B) thus obtained was BP 75.0 BP+I−I, and an optically isotropic liquid crystal phase was maintained even if the resulting material was cooled to room temperature. A peak top of a dielectric dissipation factor was located at 15 kHz, and a material capable of securing an effective dielectric constant in a high frequency region was obtained.

The cell in which polymer/liquid crystal composite material PSBP-B was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 3

Liquid crystal composition NLC-C was prepared by mixing liquid crystal compounds shown in a diagram below at a proportion below.

### Liquid Crystal Composition NLC-C

| | | |
|---|---|---|
| 5-HBB(F)B-2 | (1) | 17% |
| 3-GB(F)B(F,F)XB(F,F)-F | (2) | 3% |
| 4-GB(F)B(F,F)XB(F,F)-F | (2) | 3% |
| 5-GB(F)B(F,F)XB(F,F)-F | (2) | 3% |
| 1-GB(F,F)XB(F)B(F,F)-F | (2) | 8% |
| 2-GB(F,F)XB(F)B(F,F)-F | (2) | 18% |
| 3-GB(F,F)XB(F)B(F,F)-F | (2) | 18% |
| 4-B(F)B(F,F)B(F,F)XB(F,F)-F | (3) | 2% |
| 5-B(F)B(F,F)B(F,F)XB(F,F)-F | (3) | 2% |
| 6-B(F)B(F,F)B(F,F)XB(F,F)-F | (3) | 2% |
| 3-B(F)B(F,F)B(F,F)XB(F,F)-CF3 | (3) | 2.5% |
| 4-B(F)B(F,F)B(F,F)XB(F,F)-CF3 | (3) | 2.5% |
| 5-B(F)B(F,F)B(F,F)XB(F,F)-CF3 | (3) | 2.5% |
| 6-B(F)B(F,F)B(F,F)XB(F,F)-CF3 | (3) | 2.5% |
| 2-HH-3 | (4) | 5% |
| H-BOB-F | (4) | 4% |
| 3-BB(F)B(F,F)-F | (4) | 5% |

A maximum temperature (° C.) of liquid crystal composition NLC-C was 90.3 to 102.9.

Next, liquid crystal composition CLC-C composed of liquid crystal composition NLC-C (95.0% by weight) and chiral agent (8H)BN-H5 (5.0% by weight) was obtained. A phase transition temperature (° C.) of liquid crystal composition CLC-C was N* 81.5 to 82.2 BP−BP+I 92.0 I.

### Preparation of a Mixture (MLC-C) of a Polymerizable Monomer and a Liquid Crystal Composition

As a mixture of a liquid crystal composition and a polymerizable monomer, mixture MLC-C was prepared, in which 87.9% by weight of liquid crystal composition CLC-C, 6.5% by weight of n-hexadecyl acrylate, 5.2% by weight of benzene-1,2,4-triyltris(4-(12-(acryloyloxy)dodecyloxy)benzoyloxy)benzoate (LCA-2) and 0.4% by weight of 2,2′-dimethoxyphenylacetophenone as a photopolymerization initiator were mixed. A phase transition temperature (° C.) of mixture MLC-C was N* 53.8 to 54.4 BP−BP+I 68.8 I.

### Preparation of a Polymer/Liquid Crystal Composite Material (PSBP-C)

Mixture MLC-C was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 23 mWcm⁻² (365 nm)) for 1 minute to perform a polymerization reaction. A phase transition temperature (° C.) of the polymer/liquid crystal composite material (PSBP-C) thus obtained was BP 75.0 BP+I−I, and an optically isotropic liquid crystal phase was maintained even if the resulting material was cooled to room temperature. A peak top of a dielectric dissipation factor was located at 15 kHz, and a material capable of securing an effective dielectric constant in a high frequency region was obtained.

The cell in which polymer/liquid crystal composite material PSBP-C was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 4

Liquid crystal composition NLC-D was prepared by mixing liquid crystal compounds shown in a diagram below at a proportion below.

### Liquid Crystal Composition NLC-D

| | | |
|---|---|---|
| 4-HHBB(F,F)-F | (1) | 10% |
| 3-GB(F)B(F,F)XB(F,F)-F | (2) | 11.7% |
| 4-GB(F)B(F,F)XB(F,F)-F | (2) | 10.8% |
| 5-GB(F)B(F,F)XB(F,F)-F | (2) | 10.8% |
| 2-GB(F,F)XB(F)B(F,F)-F | (2) | 16.2% |
| 3-GB(F,F)XB(F)B(F,F)-F | (2) | 16.2% |
| 4-B(F)B(F,F)B(F,F)XB(F,F)-F | (3) | 6.3% |
| 5-B(F)B(F,F)B(F,F)XB(F,F)-F | (3) | 6.3% |
| 6-B(F)B(F,F)B(F,F)XB(F,F)-F | (3) | 6.3% |
| 3-B(F)B(F,F)B(F,F)XB(F,F)-CF3 | (3) | 2.7% |
| 4-B(F)B(F,F)B(F,F)XB(F,F)-CF3 | (3) | 2.7% |

A maximum temperature (° C.) of liquid crystal composition NLC-D was 105.4 to 106.6.

Next, liquid crystal composition CLC-D composed of liquid crystal composition NLC-D (95.0% by weight) and chiral agent (8H)BN-H5 (5.0% by weight) was obtained. A phase transition temperature (° C.) of liquid crystal composition CLC-D was N* 96.3 to 96.6 BP−BP+I−I.

### Preparation of a Mixture (MLC-D) of a Polymerizable Monomer and a Liquid Crystal Composition

As a mixture of a liquid crystal composition and a polymerizable monomer, mixture MLC-D was prepared, in which 87.9% by weight of liquid crystal composition CLC-D, 6.5% by weight of n-hexadecyl acrylate, 5.2% by weight of benzene-1,2,4-triyltris(4-(12-(acryloyloxy)dodecyloxy)benzoyloxy)benzoate (LCA-2) and 0.4% by weight of 2,2′-dimethoxyphenylacetophenone as a photopolymerization initiator were mixed. A phase transition temperature (° C.) of mixture MLC-D was N* 64.6 to 65.2 BP−BP+I−I.

### Preparation of a Polymer/Liquid Crystal Composite Material (PSBP-D)

Mixture MLC-D was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 23 mWcm⁻² (365 nm)) for 1 minute to perform a polymerization reaction. A phase transition temperature (° C.) of the polymer/liquid crystal composite material (PSBP-D) thus obtained was BP 92.0 BP+I−I, and an optically isotropic liquid crystal phase was maintained even if the resulting material was cooled to room temperature. A peak top of a dielectric dissipation factor was located at 20 kHz, and a material capable of securing an effective dielectric constant in a high frequency region was obtained.

The cell in which polymer/liquid crystal composite material PSBP-D was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 5

Liquid crystal composition NLC-E was prepared by mixing liquid crystal compounds shown in a diagram below at a proportion below.

### Liquid Crystal Composition NLC-E

| | | |
|---|---|---|
| 5-HBB(F)B-2 | (1) | 4% |
| 5-HBB(F)B-3 | (1) | 4% |
| 3-GB(F)B(F,F)XB(F,F)-F | (2) | 5% |
| 4-GB(F)B(F,F)XB(F,F)-F | (2) | 10% |
| 5-GB(F)B(F,F)XB(F,F)-F | (2) | 6.9% |
| 3-GB(F,F)XB(F)B(F,F)-F | (2) | 12% |
| 4-GB(F,F)XB(F)B(F,F)-F | (2) | 15% |
| 5-GB(F,F)XB(F)B(F,F)-F | (2) | 15% |
| 4-B(F)B(F,F)B(F,F)XB(F,F)-F | (3) | 2.5% |
| 5-B(F)B(F,F)B(F,F)XB(F,F)-F | (3) | 2.5% |
| 3-B(F)B(F,F)B(F,F)XB(F,F)-CF3 | (3) | 1.5% |
| 4-B(F)B(F,F)B(F,F)XB(F,F)-CF3 | (3) | 4.2% |
| 5-B(F)B(F,F)B(F,F)XB(F,F)-CF3 | (3) | 4.2% |
| 6-B(F)B(F,F)B(F,F)XB(F,F)-CF3 | (3) | 4.2% |
| 3-B(F)B(F,F)XB(F)B(F,F)-F | (3) | 3% |
| 5-B(F)B(F,F)XB(F)B(F,F)-F | (3) | 6% |

### Preparation of a Mixture (MLC-E) of a Polymerizable Monomer and a Liquid Crystal Composition

Mixture MLC-E of a polymerizable monomer and a liquid crystal composition was prepared as described below.

| | | |
|---|---|---|
| Liquid crystal composition NLC-E | 100 | pts. wt. |
| Chiral agent (8H)BN-H5 | 5 | pts. wt. |
| n-Hexadecyl acrylate | 6 | pts. wt. |
| Benzene-1,2,4-triyltris(4-(12- | 6 | pts. wt. |
| (acryloyloxy)dodecyloxy)benzoyloxy)benzoate | | |
| (LCA-2) | | |
| Photopolymerization initiator | 0.5 | pt. wt. |
| 2,2′-dimethoxyphenylacetophenone | | |

A phase transition temperature (° C.) of mixture MLC-E was N* 66.7 to 67.1 BP−I.

### Preparation of a Polymer/Liquid Crystal Composite Material (PSBP-E)

Mixture MLC-E was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 2 mWcm⁻² (365 nm)) for 420 seconds to perform a polymerization reaction. A phase transition temperature (° C.) of the polymer/liquid crystal composite material (PSBP-E) thus obtained was BP 94.0 I, and an optically isotropic liquid crystal phase was maintained even if the resulting material was cooled to room temperature. A peak top of a dielectric dissipation factor was located at 40 kHz, and a material capable of securing an effective dielectric constant in a high frequency region was obtained.

The cell in which polymer/liquid crystal composite material PSBP-E was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 6

Liquid crystal composition NLC-F was prepared by mixing liquid crystal compounds shown in a diagram below at a proportion below.

### Liquid Crystal Composition NLC-F

| | | |
|---|---|---|
| 5-HBB(F)B-2 | (1) | 3% |
| 5-HBB(F)B-3 | (1) | 3% |
| 3-GB(F)B(F,F)XB(F,F)-F | (2) | 5% |
| 4-GB(F)B(F,F)XB(F,F)-F | (2) | 9% |
| 5-GB(F)B(F,F)XB(F,F)-F | (2) | 6.9% |
| 3-GB(F,F)XB(F)B(F,F)-F | (2) | 12% |
| 4-GB(F,F)XB(F)B(F,F)-F | (2) | 15% |
| 5-GB(F,F)XB(F)B(F,F)-F | (2) | 15% |
| 4-B(F)B(F,F)B(F,F)XB(F,F)-F | (3) | 2.5% |
| 5-B(F)B(F,F)B(F,F)XB(F,F)-F | (3) | 2.5% |
| 3-B(F)B(F,F)B(F,F)XB(F,F)-CF3 | (3) | 1.5% |
| 4-B(F)B(F,F)B(F,F)XB(F,F)-CF3 | (3) | 4.2% |
| 5-B(F)B(F,F)B(F,F)XB(F,F)-CF3 | (3) | 4.2% |
| 6-B(F)B(F,F)B(F,F)XB(F,F)-CF3 | (3) | 4.2% |
| 3-B(F)B(F,F)XB(F)B(F,F)-F | (3) | 6% |
| 5-B(F)B(F,F)XB(F)B(F,F)-F | (3) | 6% |

### Preparation of a Mixture (MLC-F) of a Polymerizable Monomer and a Liquid Crystal Composition

Mixture MLC-F of a polymerizable monomer and a liquid crystal composition was prepared as described below.

| | | |
|---|---|---|
| Liquid crystal composition NLC-F | 100 | pts. wt. |
| Chiral agent (8H)BN-H5 | 5 | pts. wt. |
| n-Hexadecyl acrylate | 6 | pts. wt. |
| Benzene-1,2,4-triyltris(4-(12- | 6 | pts. wt. |
| (acryloyloxy)dodecyloxy)benzoyloxy)benzoate | | |
| (LCA-2) | | |
| Photopolymerization initiator | 0.5 | pt. wt. |
| 2,2′-dimethoxyphenylacetophenone | | |

A phase transition temperature (° C.) of mixture MLC-F was N* 62.4 to 63.0 BP−I.

### Preparation of a Polymer/Liquid Crystal Composite Material (PSBP-F)

Mixture MLC-F was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 2 mWcm⁻² (365 nm)) for 420 seconds to perform a polymerization reaction. A phase transition temperature (° C.) of the polymer/liquid crystal composite material (PSBP-F) thus obtained was BP 88.0 I, and an optically isotropic liquid crystal phase was maintained even if the resulting material was cooled to room temperature. A peak top of a dielectric dissipation factor was located at 30 kHz, and a material capable of securing an effective dielectric constant in a high frequency region was obtained.

The cell in which polymer/liquid crystal composite material PSBP-F was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 7

Liquid crystal composition NLC-G was prepared by mixing liquid crystal compounds shown in a diagram below at a proportion below.

### Liquid Crystal Composition NLC-G

| | | |
|---|---|---|
| 5-HBB(F)B-2 | (1) | 3% |
| 5-HBB(F)B-3 | (1) | 3% |
| 3-GB(F)B(F,F)XB(F,F)-F | (2) | 5% |
| 4-GB(F)B(F,F)XB(F,F)-F | (2) | 9% |
| 5-GB(F)B(F,F)XB(F,F)-F | (2) | 9% |
| 3-GB(F,F)XB(F)B(F,F)-F | (2) | 10% |
| 4-GB(F,F)XB(F)B(F,F)-F | (2) | 14% |
| 5-GB(F,F)XB(F)B(F,F)-F | (2) | 14% |
| 4-B(F)B(F,F)B(F,F)XB(F,F)-F | (3) | 2.3% |
| 5-B(F)B(F,F)B(F,F)XB(F,F)-F | (3) | 2.3% |
| 3-B(F)B(F,F)B(F,F)XB(F,F)-CF3 | (3) | 2% |
| 4-B(F)B(F,F)B(F,F)XB(F,F)-CF3 | (3) | 3.8% |
| 5-B(F)B(F,F)B(F,F)XB(F,F)-CF3 | (3) | 3.8% |
| 6-B(F)B(F,F)B(F,F)XB(F,F)-CF3 | (3) | 3.8% |
| 3-B(F)B(F,F)XB(F)B(F,F)-F | (3) | 5% |
| 4-B(F)B(F,F)XB(F)B(F,F)-F | (3) | 5% |
| 5-B(F)B(F,F)XB(F)B(F,F)-F | (3) | 5% |

### Preparation of a Mixture (MLC-G) of a Polymerizable Monomer and a Liquid Crystal Composition

Mixture MLC-G of a polymerizable monomer and a liquid crystal composition was prepared as described below.

| | | |
|---|---|---|
| Liquid crystal composition NLC-G | 100 | pts. wt. |
| Chiral agent (8H)BN-H5 | 5 | pts. wt. |
| n-Hexadecyl acrylate | 6 | pts. wt. |
| Benzene-1,2,4-triyltris(4-(12- | 6 | pts. wt. |
| (acryloyloxy)dodecyloxy)benzoyloxy)benzoate | | |
| (LCA-2) | | |
| Photopolymerization initiator | 0.5 | pt. wt. |
| 2,2′-dimethoxyphenylacetophenone | | |

A phase transition temperature (° C.) of mixture MLC-G was N* 62.4 to 63.0 BP−I.

### Preparation of a Polymer/Liquid Crystal Composite Material (PSBP-G)

Mixture MLC-G was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 2 mWcm⁻² (365 nm)) for 420 seconds to perform a polymerization reaction. A phase transition temperature (° C.) of the polymer/liquid crystal composite material (PSBP-G) thus obtained was BP 87.0 I, and an optically isotropic liquid crystal phase was maintained even if the resulting material was cooled to room temperature. A peak top of a dielectric dissipation factor was located at 25 kHz, and a material capable of securing an effective dielectric constant in a high frequency region was obtained.

The cell in which polymer/liquid crystal composite material PSBP-G was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 8

Liquid crystal composition NLC-H was prepared by mixing liquid crystal compounds shown in a diagram below at a proportion below.

### Liquid Crystal Composition NLC-H

| | | |
|---|---|---|
| 3-BBB(F)B(F,F)-F | (1) | 4% |
| 4-BBB(F)B(F,F)-F | (1) | 4% |
| 3-GB(F)B(F,F)XB(F,F)-F | (2) | 5% |
| 4-GB(F)B(F,F)XB(F,F)-F | (2) | 10% |
| 5-GB(F)B(F,F)XB(F,F)-F | (2) | 6.9% |
| 3-GB(F,F)XB(F)B(F,F)-F | (2) | 12% |
| 4-GB(F,F)XB(F)B(F,F)-F | (2) | 15% |
| 5-GB(F,F)XB(F)B(F,F)-F | (2) | 15% |
| 4-B(F)B(F,F)B(F,F)XB(F,F)-F | (3) | 2.5% |
| 5-B(F)B(F,F)B(F,F)XB(F,F)-F | (3) | 2.5% |
| 3-B(F)B(F,F)B(F,F)XB(F,F)-CF3 | (3) | 1.5% |
| 4-B(F)B(F,F)B(F,F)XB(F,F)-CF3 | (3) | 4.2% |
| 5-B(F)B(F,F)B(F,F)XB(F,F)-CF3 | (3) | 4.2% |
| 6-B(F)B(F,F)B(F,F)XB(F,F)-CF3 | (3) | 4.2% |
| 3-B(F)B(F,F)XB(F)B(F,F)-F | (3) | 3% |
| 5-B(F)B(F,F)XB(F)B(F,F)-F | (3) | 6% |

### Preparation of a Mixture (MLC-H) of a Polymerizable Monomer and a Liquid Crystal Composition

Mixture MLC-H of a polymerizable monomer and a liquid crystal composition was prepared as described below.

| | | |
|---|---|---|
| Liquid crystal composition NLC-H | 100 | pts. wt. |
| Chiral agent (8H)BN-H5 | 4 | pts. wt. |
| n-Hexadecyl acrylate | 5 | pts. wt. |
| Benzene-1,2,4-triyltris(4-(12- | 5 | pts. wt. |
| (acryloyloxy)dodecyloxy)benzoyloxy)benzoate | | |
| (LCA-2) | | |
| Photopolymerization initiator | 0.5 | pt. wt. |
| 2,2′-dimethoxyphenylacetophenone | | |

A phase transition temperature (° C.) of mixture MLC-H was N* 66.3 to 66.9 BP−I.

### Preparation of a Polymer/Liquid Crystal Composite Material (PSBP-H)

Mixture MLC-H was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 2 mWcm⁻² (365 nm)) for 420 seconds to perform a polymerization reaction. A phase transition temperature (° C.) of the polymer/liquid crystal composite material (PSBP-H) thus obtained was BP 89.6 I, and an optically isotropic liquid crystal phase was maintained even if the resulting material was cooled to room temperature. A peak top of a dielectric dissipation factor was located at 50 kHz, and a material capable of securing an effective dielectric constant in a high frequency region was obtained.

The cell in which polymer/liquid crystal composite material PSBP-H was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

### Example 9

Liquid crystal composition NLC-I was prepared by mixing liquid crystal compounds shown in a diagram below at a proportion below.

### Liquid Crystal Composition NLC-I

| | | |
|---|---|---|
| 3-GBB(F)B(F,F)-F | (1) | 3% |
| 4-GBB(F)B(F,F)-F | (1) | 5% |
| 3-GB(F)B(F,F)XB(F,F)-F | (2) | 5% |
| 4-GB(F)B(F,F)XB(F,F)-F | (2) | 10% |
| 5-GB(F)B(F,F)XB(F,F)-F | (2) | 6.9% |
| 3-GB(F,F)XB(F)B(F,F)-F | (2) | 12% |
| 4-GB(F,F)XB(F)B(F,F)-F | (2) | 15% |
| 5-GB(F,F)XB(F)B(F,F)-F | (2) | 15% |
| 4-B(F)B(F,F)B(F,F)XB(F,F)-F | (3) | 2.5% |
| 5-B(F)B(F,F)B(F,F)XB(F,F)-F | (3) | 2.5% |
| 3-B(F)B(F,F)B(F,F)XB(F,F)-CF3 | (3) | 1.5% |
| 4-B(F)B(F,F)B(F,F)XB(F,F)-CF3 | (3) | 4.2% |
| 5-B(F)B(F,F)B(F,F)XB(F,F)-CF3 | (3) | 4.2% |
| 6-B(F)B(F,F)B(F,F)XB(F,F)-CF3 | (3) | 4.2% |
| 3-B(F)B(F,F)XB(F)B(F,F)-F | (3) | 3% |
| 5-B(F)B(F,F)XB(F)B(F,F)-F | (3) | 6% |

### Preparation of a Mixture (MLC-I) of a Polymerizable Monomer and a Liquid Crystal Composition

Mixture MLC-H of a polymerizable monomer and a liquid crystal composition was prepared as described below.

| | | |
|---|---|---|
| Liquid crystal composition NLC-I | 100 | pts. wt. |
| Chiral agent (8H)BN-H5 | 4 | pts. wt. |
| n-Hexadecyl acrylate | 5 | pts. wt. |
| Benzene-1,2,4-triyltris(4-(12- | 5 | pts. wt. |
| (acryloyloxy)dodecyloxy)benzoyloxy)benzoate | | |
| (LCA-2) | | |
| Photopolymerization initiator | 0.5 | pt. wt. |
| 2,2′-dimethoxyphenylacetophenone | | |

A phase transition temperature (° C.) of mixture MLC-I was N* 65.5 to 66.1 BP−I.

### Preparation of a Polymer/Liquid Crystal Composite Material (PSBP-I)

Mixture MLC-I was interposed between two glass substrates with electrodes subjected to no alignment treatment (cell thickness: 10 μm, electrode area: 0.16 cm²), and the cell obtained was heated to a blue phase. In the state, the cell was irradiated with ultraviolet light (ultraviolet light intensity: 2 mWcm⁻² (365 nm)) for 420 seconds to perform a polymerization reaction. A phase transition temperature (° C.) of the polymer/liquid crystal composite material (PSBP-I) thus obtained was BP 88.8 I, and an optically isotropic liquid crystal phase was maintained even if the resulting material was cooled to room temperature. A peak top of a dielectric dissipation factor was located at 50 kHz, and a material capable of securing an effective dielectric constant in a high frequency region was obtained.

The cell in which polymer/liquid crystal composite material PSBP-I was interposed therebetween was set to an optical system shown in FIG. 1, and electro-optical characteristics were measured. A white light source of a polarized-light microscope (made by Nikon Corporation, ECLIPS LV100POL) was used as a light source, and the cell was set to be at an angle of 45 degrees oblique to a cell surface in an incident angle to the cell. An optical change was observed by voltage application at room temperature, and capability of polarized light control was confirmed.

The liquid crystal medium exhibiting the optically isotropic liquid crystal phase of the present application was found to be able to be preferably used in the device for controlling retardation or the device for controlling polarized light (switching between right-handed circularly polarized light and left-handed circularly polarized light), particularly using a blue phase liquid crystal medium in which reduction of the effective dielectric constant in the high frequency region was suppressed.

The disclosure includes items described below.

Item 1. A liquid crystal composition having a liquid crystal phase optically exhibiting isotropy to be used for optical switching for controlling retardation by electric field-induced birefringence, wherein a peak top of a dielectric dissipation factor is located at a frequency higher than 10 kHz.

Item 2. The liquid crystal composition according to item 1, containing achiral component T, wherein achiral component T contains at least one compound selected from the group of compounds represented by formula (1) as a first component, at least one compound selected from the group of compounds represented by formula (2) as a second component, and at least one compound selected from the group of compounds represented by formula (3) as a third component:

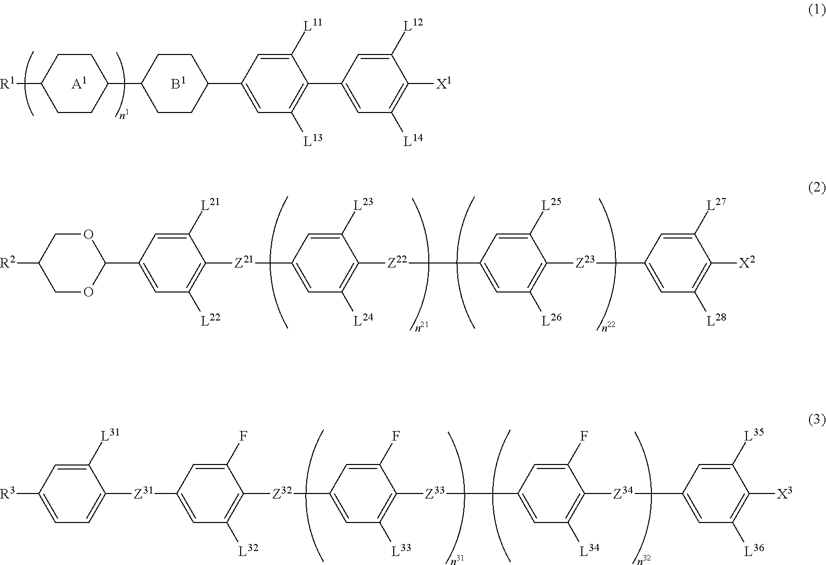

wherein, in formula (1), formula (2) and formula (3), R¹, R² and R³ are independently hydrogen or alkyl having 1 to 20 carbons, and in R¹, R² and R³, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R², a case where —O— and —CH═CH—, and —CO— and —CH═CH— are adjacent to each other is excluded, and a case where R¹, R² and R³ become fluorine or chlorine is excluded;

ring A¹ and ring B¹ are independently 1,4-cyclohexylene, 1,4-phenylene, 2-fluoro-1,4-phenylene, 3-fluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl;

n¹ is 1 or 2, and when n¹ is 2, a plurality of rings A¹ may be identical to or different from each other;

n²¹, n²², n³¹ and n³² are 0 or 1, a sum of n²¹ and n²² is 1 or 2, and a sum of n³¹ and n³² is 1 or 2;

Z²¹ to Z²³ are independently a single bond, —COO— or —CF₂O—, at least one of the groups is —COO— or —CF₂O—, and when n²¹ is 0 and n²² is 1, at least one of Z²¹ or Z²³ is —COO— or —CF₂O—, and when n²¹ is 1 and n²² is 0, at least one of Z²¹ or Z²² is —COO— or —CF₂O—;

Z³¹ to Z³⁴ are independently a single bond, —COO— or —CF₂O—, at least one of the groups is —COO— or —CF₂O—, and when n³¹ is 0 and n³² is 1, at least one of Z³² or Z³⁴ is —COO— or —CF₂O—, and when n³¹ is 1 and n³² is 0, at least one of Z³² or Z³³ is —COO— or —CF₂O—;

L¹¹ to L¹⁴ are independently hydrogen, fluorine or chlorine;

L²¹ to L²⁸ and L³¹ to L³⁶ are independently hydrogen or fluorine; and

X¹, X² and X³ are independently hydrogen, halogen, —SF₅ or alkyl having 1 to 10 carbons, and in X¹, X² and X³, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, a case where —O— and —CH═CH—, and —CO— and —CH═CH— are adjacent to each other is excluded.

Item 3. The liquid crystal composition according to item 2, containing 1% by weight to 30% by weight of the first component, 25% by weight to 90% by weight of the second component and 5% by weight to 65% by weight of the third component, based on a total amount of achiral component T.

Item 4. The liquid crystal composition according to item 2 or 3, wherein achiral component T further contains at least one component selected from the group of compounds represented by formula (4) as a fourth component:

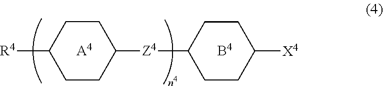

wherein, in formula (4), R⁴ is hydrogen or alkyl having 1 to 20 carbons, and in R⁴, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R⁴, a case where —O— and —CH═CH—, and —CO— and —CH═CH— are adjacent to each other is excluded, and a case where R⁴ becomes fluorine or chlorine is excluded;

ring A⁴ and ring B⁴ are independently 1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl;

Z⁴ is a single bond, —O—, —COO—, —CH₂CH₂—, —CH₂O—, —CF₂O—, —CH═CH—, —CF═CF—, and —C≡C—;

X⁴ is hydrogen, halogen, —SF₅ or alkyl having 1 to 10 carbons, and in X⁴, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in X⁴, a case where —O— and —CH═CH—, and —CO— and —CH═CH— are adjacent to each other is excluded; and

n⁴ is 1 or 2, and when n⁴ is 2, a plurality of rings A⁴ and Z⁴ may be identical to or different from each other.

Item 5. The liquid crystal composition according to any one of items 1 to 4, containing a chiral agent.

Item 6. The liquid crystal composition according to any one of items 1 to 5, containing one or more compounds selected from the group of an antioxidant and an ultraviolet light absorber.

Item 7. The liquid crystal composition according to any one of items 1 to 6, used for optical switching for controlling retardation from 0 to λ/2 by voltage application.

Item 8. The liquid crystal composition according to any one of items 1 to 6, used for switching between right-handed circularly polarized light and left-handed circularly polarized light.

Item 9. A mixture, containing the liquid crystal composition according to any one of items 1 to 8 and a polymerizable monomer.

Item 10. A polymer/liquid crystal composite material obtained by polymerizing the mixture according to item 9, used in a device driven in a liquid crystal phase optically exhibiting isotropy.

Item 11. The polymer/liquid crystal composite material according to item 10, obtained by polymerizing the mixture according to item 9 in a temperature range of a non-liquid crystal isotropic phase or a liquid crystal phase optically exhibiting isotropy.

Item 12. An optical switching device, including the liquid crystal composition according to any one of items 1 to 8, the mixture according to item 9 or the polymer/liquid crystal composite material according to item 10 or 11.

Item 13. The optical switching device according to item 12, usable for light having a wavelength of 0.72 to 2.5 micrometers.

Item 14. The optical switching device according to item 12, usable for light having a wavelength of 1 to 10 millimeters.

Item 15. A RIDER, including at least one optical switching device according to item 12.

A liquid crystal composition and a polymer/liquid crystal composite material of a preferred aspect of the disclosure exhibit stability to heat, light and so forth, a high maximum temperature and a low minimum temperature of an optically isotropic liquid crystal phase, and have large dielectric anisotropy and large refractive index anisotropy. The polymer/liquid crystal composite material of the preferred aspect of the disclosure exhibits a high maximum temperature and a low minimum temperature of the optically isotropic liquid crystal phase to suppress reduction of an effective dielectric constant in a high frequency region in a device using the optically isotropic liquid crystal phase.

Moreover, the device using the optically isotropic liquid crystal phase of the preferred aspect of the disclosure can be used in a wide temperature range, and can achieve a high-speed electro-optical response to suppress reduction of the effective dielectric constant in the high frequency region.

A liquid crystal composition of the disclosure can be utilized in an optical switching device using a polymer/liquid crystal composite material having a liquid crystal phase optically exhibiting isotropy, such as a blue phase, for example, an optical switching device such as a LIDAR.

What is claimed is:

1. A liquid crystal composition having a liquid crystal phase optically exhibiting isotropy to be used for optical switching for controlling retardation by electric field-induced birefringence, wherein a peak top of a dielectric dissipation factor is located at a frequency higher than 10 kHz.

2. The liquid crystal composition according to claim 1, containing achiral component T, wherein achiral component T contains at least one compound selected from the group of compounds represented by formula (1) as a first component, at least one compound selected from the group of compounds represented by formula (2) as a second component, and at least one compound selected from the group of compounds represented by formula (3) as a third component: 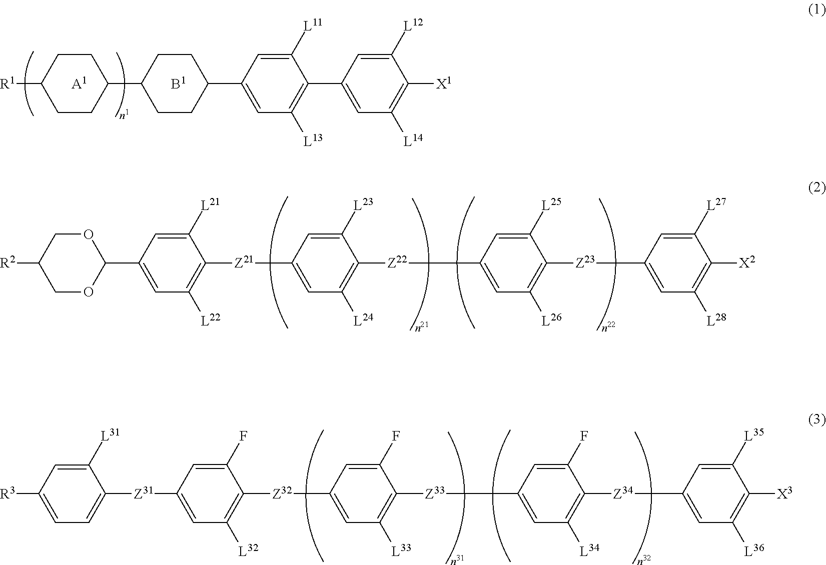
wherein, in formula (1), formula (2) and formula (3), R¹, R² and R³ are independently hydrogen or alkyl having 1 to 20 carbons, and in R¹, R² and R³, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R², a case where —O— and —CH═CH—, and —CO— and —CH═CH— are adjacent to each other is excluded, and a case where R¹, R² and R³ become fluorine or chlorine is excluded;
ring A¹ and ring B¹ are independently 1,4-cyclohexylene, 1,4-phenylene, 2-fluoro-1,4-phenylene, 3-fluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl;
n¹ is 1 or 2, and when n¹ is 2, a plurality of rings A¹ may be identical to or different from each other;
n²¹, n²², n³¹ and n³² are 0 or 1, a sum of n²¹ and n²² is 1 or 2, and a sum of n³¹ and n³² is 1 or 2;
Z²¹ to Z²³ are independently a single bond, —COO— or —CF₂O—, at least one of the groups is —COO— or —CF₂O—, and when n²¹ is 0 and n²² is 1, at least one of Z²¹ or Z²³ is —COO— or —CF₂O—, and when n²¹ is 1 and n²² is 0, at least one of Z²¹ or Z²² is —COO— or —CF₂O—;
Z³¹ to Z³⁴ are independently a single bond, —COO— or —CF₂O—, at least one of the groups is —COO— or —CF₂O—, and when n³¹ is 0 and n³² is 1, at least one of Z³² or Z³⁴ is —COO— or —CF₂O—, and when n³¹ is 1 and n³² is 0, at least one of Z³² or Z³³ is —COO— or —CF₂O—;
L¹¹ to L¹⁴ are independently hydrogen, fluorine or chlorine;
L²¹ to L²⁸ and L³¹ to L³⁶ are independently hydrogen or fluorine; and
X¹, X² and X³ are independently hydrogen, halogen, —SF₅ or alkyl having 1 to 10 carbons, and in X¹, X² and X³, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, a case where —O— and —CH═CH—, and —CO— and —CH═CH— are adjacent to each other is excluded.

3. The liquid crystal composition according to claim 2, containing 1% by weight to 30% by weight of the first component, 25% by weight to 90% by weight of the second component and 5% by weight to 65% by weight of the third component, based on a total amount of achiral component T.

4. The liquid crystal composition according to claim 2, wherein achiral component T further contains at least one component selected from the group of compounds represented by formula (4) as a fourth component: 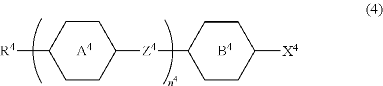
wherein, in formula (4), R⁴ is hydrogen or alkyl having 1 to 20 carbons, and in R⁴, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in R⁴, a case where —O— and —CH═CH—, and —CO— and —CH≡CH— are adjacent to each other is excluded, and a case where R⁴ becomes fluorine or chlorine is excluded;
ring A⁴ and ring B⁴ are independently 1,4-cyclohexylene, 1,4-phenylene, 2-fluoro-1,4-phenylene, 3-fluoro-1,4-phenylene, 2,5-difluoro-1,4-phenylene, 3,5-difluoro-1,4-phenylene, pyridine-2,5-diyl, pyrimidine-2,5-diyl, 1,3-dioxane-2,5-diyl or tetrahydropyran-2,5-diyl;
Z⁴ is a single bond, —O—, —COO—, —CH₂CH₂—, —CH₂O—, —CF₂O—, —CH═CH—, —CF═CF—, and —C≡C—;
X⁴ is hydrogen, halogen, —SF₅ or alkyl having 1 to 10 carbons, and in X⁴, at least one piece of —CH₂— may be replaced by —O—, —S—, —COO— or —OCO—, at least one piece of —CH₂—CH₂— may be replaced by —CH═CH—, —CF═CF— or —C≡C—, and at least one hydrogen may be replaced by fluorine or chlorine, however, in X⁴, a case where —O— and —CH═CH—, and —CO— and —CH═CH— are adjacent to each other is excluded; and
n⁴ is 1 or 2, and when n⁴ is 2, a plurality of rings A⁴ and Z⁴ may be identical to or different from each other.

5. The liquid crystal composition according to claim 1, containing a chiral agent.

6. The liquid crystal composition according to claim 1, containing one or more compounds selected from the group of an antioxidant and an ultraviolet light absorber.

7. The liquid crystal composition according to claim 1, used for optical switching for controlling retardation from 0 to λ/2 by voltage application.

8. The liquid crystal composition according to claim 1, used for switching between right-handed circularly polarized light and left-handed circularly polarized light.

9. A mixture, containing the liquid crystal composition according to claim 1 and a polymerizable monomer.

10. A polymer/liquid crystal composite material obtained by polymerizing the mixture according to claim 9, used in a device driven in a liquid crystal phase optically exhibiting isotropy.

11. The polymer/liquid crystal composite material according to claim 10, obtained by polymerizing the mixture in a temperature range of a non-liquid crystal isotropic phase or a liquid crystal phase optically exhibiting isotropy.

12. An optical switching device, including the polymer/liquid crystal composite material according to claim 10.

13. The optical switching device according to claim 12, usable for light having a wavelength of 0.72 to 2.5 micrometers.

14. The optical switching device according to claim 12, usable for light having a wavelength of 1 to 10 millimeters.

15. A RIDER, including at least one optical switching device according to claim 12.
